(19) United States
(12) Patent Application Publication
(10) Pub. No.: US 2026/0269945 A1
(43) Pub. Date: Sep. 10, 2026

(54) OPTICAL LINK FOR PROVIDING DIAGNOSIS AND MONITORING FUNCTION

(71) Applicant: OPTICIS CO., LTD., Seongnam-si (KR)

(72) Inventors: Dong Pyeong YANG, Seongnam-si (KR); Doo Soo HA, Seoul (KR)

(21) Appl. No.: 19/540,342

(22) Filed: Feb. 13, 2026

(30) Foreign Application Priority Data
Mar. 5, 2025 (KR) 10-2025-0028381
Mar. 5, 2025 (KR) 10-2025-0028382

(51) Int. Cl. H04B 10/40; H04B 10/077

(52) U.S. Cl. CPC H04B 10/40; H04B 10/0775

(57) ABSTRACT

Disclosed is an optical link in which a diagnosis and monitoring function is implemented. The optical link that provides a diagnosis and monitoring function may be implemented by creating a data frame that transmits both video auxiliary data and diagnosis data together via a side channel by using Time Division Multiplexing (TDM). More specifically, this optical link may generate a data frame that includes both time-division multiplexed video auxiliary data and diagnosis data. The video auxiliary data, such as rendering configuration information for the video data rendered through the main channel and channel configuration information for the main channel, is transmitted via the side channel. Along with this, the optical link may also transmit diagnosis data, such as information about the connection status of the optical link (which forms the main and side channels for video data transmission), the operational status of the optical link, and the identification information of the optical link itself.

### CROSS-REFERENCE TO RELATED APPLICATION(S)

This application is based on and claims priority under 35 U.S.C. § 119 to Korean Patent Application Nos. 10-2025-0028381 and 10-2025-0028382, each filed on Mar. 5, 2025, in the Korean Intellectual Property Office, the disclosures of which are incorporated by reference herein in their entireties.

### BACKGROUND

### 1. Field

The disclosure relates to an optical link for providing a diagnosis and monitoring function.

### 2. Description of the Related Art

An optical link, which provides an interface for optical communication between a source device for generating a video signal and a sink device for implementing a video image from the video signal of the source device, may include a video signal line that transmits video data, and an auxiliary signal line that, besides the video data, transmits video auxiliary data related to configuration information of the source device or the sink device.

### SUMMARY

An embodiment includes an optical link for providing a diagnosis and monitoring function, which generates a data frame for transmitting video auxiliary data and diagnosis data together from Time Division Multiplexing (TDM) via a side channel, wherein a data frame including time-division multiplexed video auxiliary data and diagnosis data so that diagnosis data may be transmitted together with the video auxiliary data via a side channel to which video auxiliary data is transmitted, wherein the video auxiliary data includes rendering configuration data to which video data transmitted via a main channel is rendered and channel configuration information of the main channel, and the diagnosis data includes information on a connection status of the optical link forming the main channel and the side channel where the video data is transmitted, information on an operational state of the optical link, and identification information of the optical link itself.

Additional aspects will be set forth in part in the description which follows and, in part, will be apparent from the description, or may be learned by practice of the presented embodiments of the disclosure.

An optical link for providing a diagnosis and monitoring function, forming a main channel through which video data is transmitted and a side channel through which video auxiliary data relating to a channel configuration of the main channel is transmitted, may generate a data frame by time-division multiplexing to transmit, through the side channel, the video auxiliary data together with diagnosis data including status information of the optical link.

For example, the data frame may include a special code area and a data area, which are assigned to time slots or sub-frames of a time-division multiplexed 8-unit.

For example, a special code assigned to the special code area may include control information for a time slot or sub-frame of a unit.

For example, for the data frame, according to whether diagnosis data is present or not, a data frame for a non-diagnosis instance, where no diagnosis data is present, may include a special code area and a data area that are alternately assigned to the time slots or sub-frames of the time-division multiplexed 8-unit, and a data frame for a diagnosis instance, in which diagnosis data is present, may include, within the time slots or sub-frames of the time-division multiplexed 8-unit: a special code area assigned to a time slot or sub-frame of a unit corresponding to a beginning of the data frame; and a sequence of data areas assigned to time slots or sub-frames of other remaining units following the time slot or sub-frame of the unit to which the special code area is assigned, along a time axis.

For example, communication traffic related to the video auxiliary data, including a request for the video auxiliary data and a response to the request may occur more frequently than communication traffic related to diagnosis data, which includes a request for the diagnosis data and a response to the request.

For example, in the optical link for providing a diagnosis and monitoring function, according to an embodiment, synchronous time-division multiplexing (STDM), in which, for the data frame of the non-diagnosis instance where the diagnosis data is not present, the time slot or sub-frame assigned to the diagnosis data may be implemented to be filled with stuffing symbols instead of video auxiliary data.

For example, the data frames of the non-diagnosis and diagnosis instances may include a Video Interface Signal segment corresponding to the beginning of the data frame, and Side First, Side Second, and Side Third packet segments that follow the Video Interface Signal segment along the time axis, the Video Interface Signal segment may include a special code area and a data area, the special code area of the Video Interface Signal segment may be assigned to a special code indicating the start of the data frame, and the data area of the Video Interface Signal segment may be assigned to video auxiliary data.

For example, each of the Side First, Side Second, and Side Third packet segments of the data frames of the non-diagnosis instance may include a special code area and a data area, and the data areas of the Side First, Side Second, and Side Third packet segments may be filled with stuffing symbols in place of diagnosis data that does not exist.

For example, each of the Side First, Side Second, and Side Third packet segments of the data frame of the diagnosis instance may include time slots or sub-frames of two-units that precede and follow along the time axis, a preceding time slot of the Side First packet may be filled with a diagnosis data start symbol, and a following time slot of the Side Third packet may be filled with a diagnosis data end symbol, and from a following time slot of the Side First packet to a preceding time slot of the Side Third packet, the time slots may be filled with diagnosis data along the time axis.

For example, the preceding time slot or sub-frame of the Side First packet and the following time slot or sub-frame of the Side Third packet may be filled with a diagnosis data start symbol and a diagnosis data end symbol, respectively, wherein the preceding time slot or sub-frame of the Side First packet and the following time slot or sub-frame of the Side Third packet may be assigned as a modifiable data area between communication hosts.

For example, the time-division multiplexed time slots or sub-frames may be assigned as 8 bits.

For example, the data frame may be assigned as a total of 64 bits of eight units, with each unit being a time-division multiplexed time slot or sub-frame assigned as 8 bits.

For example, the optical link may include a Field-Programmable Gate Array (FPGA) block for generating the data frame, the FPGA block being connected to the side channel.

For example, the FPGA block may include a multiplexer for selecting and outputting an input channel assigned to a current time slot or sub-frame from among a plurality of input channels that are multiplexed through time-division multiplexed time slots or sub-frames.

For example, the data frame, according to whether diagnosis data is present or not, during generation of a data frame for a non-diagnosis instance in which diagnosis data is not present, a special code, video auxiliary data, and stuffing symbols that replace diagnosis data may be stored in a plurality of input channels of the multiplexer or a plurality of input registers connected to the plurality of input channels, and during generation of a data frame for a diagnosis instance in which diagnosis data is present, a special code, video auxiliary data, and diagnosis data may be stored in a plurality of input channels of the multiplexer or a plurality of input registers connected to the plurality of input channels.

For example, the FPGA block may include a Serializer+Deserializer (SerDes) for converting parallel data, output from an output channel of the multiplexer, into serial data, wherein the parallel data forms either a special code, video auxiliary data, and diagnosis data, or video auxiliary data and stuffing symbols.

For example, the SerDes may output a sequence of serial data that forms a data frame in which video auxiliary data and diagnosis data or video auxiliary data and stuffing symbols are multiplexed, by taking as an input a sequence of parallel data that forms a data frame in which video auxiliary data and diagnosis data or video auxiliary data and stuffing symbols are multiplexed.

For example, the optical link for providing a diagnosis and monitoring function, according to an embodiment, may include an optical communication module in which a USB-UART converter is connected between the FPGA block and a USB port, as an optical communication module including the FPGA block.

For example, the USB-UART converter may include: a UART interface as a thread executed to convert UART communication data transmitted from the FPGA block into USB communication data transmitted toward an administrator interface connected to the USB port; and a USB interface as a thread executed to convert USB communication data transmitted from an administrator interface connected to the USB interface into UART communication data transmitted toward the FPGA block.

For example, the UART communication data converted through the USB interface may be converted from serial data into parallel data through the SerDes of an FPGA block and processed according to a logic configured in the FPGA block.

For example, the FPGA block may include an FPGA control logic for performing processing according to a pre-configured process or logic, and a memory interlocked with the FPGA control logic so that data is read, written, and updated, and diagnosis data and/or video auxiliary data stored in the memory may be transmitted, updated, or changed according to a process or logic configured in the FPGA control logic that is called according to a control command transmitted from an administrator interface, which forms the optical communication module and a USB communication channel.

For example, the optical link forms the main channel and a side channel between a display source and a display sink, the FPGA block may include a first FPGA block connected adjacent to the display source and a second FPGA block connected adjacent to the display sink,
wherein the first FPGA block may store, in a memory thereof, diagnosis data received through communication with the second FPGA block, the diagnosis data being diagnosis data for a connection status between an adjacently connected display source and an optical link and diagnosis data for a connection status between the optical link and a display sink connected on the opposite side to the optical link, the second FPGA block may store, in a memory thereof, diagnosis data received through communication with the first FPGA block, the diagnosis data being diagnosis data for a connection state between an adjacently connected display sink and the optical link and diagnosis data for a connection status of the optical link and a display source connected on the opposite to the optical link, and the first FPGA block or the second FPGA block may transmit, update, or change the diagnosis data for the connection state between the display source and the optical link and the diagnosis data for the connection state between the display sink and the optical link, which are stored in its memory, according to a pre-configured process or logic, in a way that follows a control command transmitted from an administrator interface forming a communication channel with the first FPGA block or the second FPGA block.

An optical link for providing a diagnosis and monitoring function, according to an embodiment, may include an optical communication module including the FPGA block, in which a re-timer is connected on a main channel for transmission of video data, the FPGA block is connected on a side channel for transmission of video auxiliary data, and a photoelectric conversion element is connected on the main channel and the side channel.

For example, the optical communication module may further include a USB-UART converter, which is connected between the FPGA block and a USB port.

For example, the USB-UART converter may include: a USB interface as a thread executed to convert USB communication data transmitted from an administrator interface connected to the USB port into UART communication data transmitted toward the FPGA block; and a UART interface as a thread executed to convert UART communication data transmitted from the FPGA block into USB communication data transmitted toward an administrator interface connected to a USB port.

For example, the USB interface and the UART interface may execute the USB-UART conversion after completion of transmission up to last byte of a series of consecutive data transmitted from one side to the other between a USB-UART converter and the administrator interface connected to the USB port, or after completion of transmission up to last byte of a series of consecutive data transmitted from one side to the other between the FPGA block and the USB-UART converter.

For example, the diagnosis data may include at least one of a connection status of the optical link, an operational status of the optical link, and identification information of the optical link itself.

For example, the video auxiliary data may include: channel configuration data related to channel configuration of a main channel for transmitting video auxiliary data; and rendering configuration data related to rendering of a display sink where the video data is rendered.

Meanwhile, an optical link for providing a diagnosis and monitoring function, according to another aspect of the disclosure, may transmit, together with the video auxiliary data, diagnosis data related to a status of the optical link, wherein the optical link includes a main channel through which video data is transmitted and a side channel through which video auxiliary data is transmitted, the video auxiliary data including rendering configuration data of the video auxiliary data transmitted via the main channel and channel configuration data of the main channel.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 shows a diagram for describing, according to an embodiment, a main channel for video data transmission in a display port (DP) to which an optical link for providing a diagnosis and monitoring function is applicable, and a side channel for transmitting video auxiliary data and diagnosis data;

FIG. 2 shows a diagram for describing, according to an embodiment, a main channel for video data transmission in High-Definition Multimedia Interface (HDMI) to which an optical link for providing a diagnosis and monitoring function is applicable, and a side channel for transmitting video auxiliary data and diagnosis data;

FIG. 3 is a diagram for describing a Field-Programmable Gate Array (FPGA) block shown in FIG. 1 or 2, in which are described: a configuration including an FPGA control logic in which a logic or process is configured to process video auxiliary data and diagnosis data, a memory (random-access memory (RAM)) storing the video auxiliary data and diagnosis data processed from the FPGA control logic, and a Serializer+Deserializer (SerDes) for conversion between serial data and parallel data input to and output from the FPGA block; and a configuration of the FPGA block that includes a Universal Asynchronous Receiver-Transmitter (UART) communication channel formed between the FPGA block and a UART-to-Universal Serial Bus (USB) converter within an optical communication module, and a communication channel formed with a peripheral circuit for the generation of diagnosis data, including an operational status of an optical link, such as an operation temperature or an operation voltage.

FIGS. 4A and 4B are diagrams for describing an optical communication module including the FPGA block shown in FIG. 3, showing an optical transmitter for video data transmission and an optical receiver for video data reception, respectively, wherein each of the optical transmitter and the optical receiver includes a re-timer connected on the main channel for video data transmission, and an FPGA block connected on the side channel for transmission of video auxiliary data and diagnosis data, a photoelectric conversion element connected to both the main channel and the side channel, and a USB-to-UART converter formed on a data transmission channel between an administrator interface and the FPGA block connected through USB communication;

FIG. 5 is a diagram for describing the USB-to-UART converter of the optical transmitter and the optical receiver (optical communication module) respectively shown in FIGS. 4A and 4B, and shows a USB interface for converting, into UART communication data, USB communication data that is input from the administrator interface USB-connected to the optical transmitter and the optical receiver (optical communication channel), and a UART interface for converting UART communication data that is input from the FPGA block of the optical transmitter and the optical receiver into USB communication data;

FIG. 6 shows a diagram for describing a memory structure that includes two different threads, a UART interface (for converting input UART communication data into USB communication data) and a USB interface (for converting input USB communication data into UART communication data), of a USB controller shown in FIG. 5, where an execution environment is provided within the same process where a code area (e.g., storing a function), a data area (e.g., storing a global variable), and a heap area (dynamic allocation memory) of a memory are shared while separately assigning a stack area (e.g., storing function parameters), in a process for providing an execution environment for the two threads;

FIG. 7 shows a diagram for describing a case where, in the UART interface and the USB interface, which are the two different threads (thread A and thread B) shown in FIG. 6, where the execution environment is provided within the same process, main functions of the respective threads (thread A's main and thread B's main) and functions (add, minus, divide, and a plurality of) called from the main functions are stored in the code area in which they are shared with each other;

FIG. 8 is a diagram for describing Time-Division Multiplexing (TDM) of video auxiliary data and diagnosis data for the transmission of the video auxiliary data and the diagnosis data together, and shows the formation of a data frame in which the video auxiliary data and the diagnosis data are multiplexed through a time slot or sub-frame, which are obtained by TDM through a multiplexer from an input channel, or an input register connected thereto, storing the video auxiliary data and the diagnosis data, and the formation of a data frame of serial data from a Serializer+Deserializer (SerDes) to which a data frame of parallel data is input;

FIG. 9 is a diagram schematically illustrating a process flow of video auxiliary data and diagnosis data transmitted via a side channel, wherein an FPGA block includes an encoder/decoder that receives multiplexed video auxiliary data and diagnosis data output from a multiplexer (MUX), which is for multiplexing first to eighth input channels input from an input register of an FPGA control logic, and a SerDes for converting between parallel data and serial data of the video auxiliary data and the diagnosis data;

FIG. 10A is a diagram for describing Synchronous TDM (STDM) as an embodiment of TDM shown in FIG. 9;

FIG. 10B shows a diagram for describing an Asynchronous TDM (ATDM) compared to STDM shown in FIG. 10A;

FIG. 11 is a diagram for describing a data frame of a non-diagnosis instance including only video auxiliary data rather than diagnosis data;

FIG. 12 is a diagram for describing a data frame of a diagnosis instance including diagnosis data together with video data;

FIG. 13 is a diagram for describing an embodiment of STDM in which a stuffing symbol is filled in a time slot or sub-frame assigned to diagnosis data, in a data frame of a non-diagnosis instance without diagnosis data, and shows compatibility with an optical link to which a constant transmission capacity is assigned in a data frame not including diagnosis data;

FIG. 14 shows a diagram for describing an overall structure of a system for implementing diagnosis and monitoring of an optical link, according to an embodiment;

FIG. 15 is a diagram for describing a USB host controller shown in FIG. 14;

FIG. 16 is a diagram for describing multiplexing of a plurality of data transmission channels respectively connected to optical links between the FPGA circuit and the MCU shown in FIG. 4 from TDM through a single connection channel between the FPGA circuit and the MCU;

FIG. 17 shows a diagram for describing a data structure of universal achromous receiver/transmitter (UART) communication data that is converted from a USB interface of a USB host controller, which receives USB communication data, and transmitted toward a UART-parallel converter, wherein the UART communication data structure includes Start bit, Data bit, Parity bit, Stop bit, and IDLE period;

FIG. 18 is a diagram for describing a USB connection between the USB host controller and the optical link shown in FIG. 14, wherein a USB connection with the USB host controller as a host (Down Facing Port (DFP)) and the optical link as a device (Up Facing Port (UFP)), a CC logic and Vconn switch for controlling a MUX for allowing un-flipped or flipped connection corresponding to plug orientation depending on the connection status between them and switching between input and output channels of the MUX, and for power supply of an Electronically Marked IC (EMIC);

FIG. 19 is a diagram for describing a pin configuration and configuration control of a USB port (USB C-type) in a USB connection between the USB host controller and the optical link shown in FIG. 14, wherein Configuration Channels (CC) (CC1 and CC2) detect USB connection/separation and are involved in role determination and plug orientation (un-filled or flipped) between USB communication hosts and power delivery (PD) communication (or baseband communication);

FIG. 20 is a diagram for describing USB communication between the USB host controller and the optical link shown in FIG. 14, wherein, in USB communication with the USB host controller as a host and the optical link as a device, the USB connection and plug orientation (un-filled or flipped) are detected, and for role determination, shown are a pull-up resistor (Rp) connected to CC of the USB host controller forming the host, a pull-down resistor (Rd) connected to CC of the optical link forming the device, and a resistor (Ra) capable of detecting active cable circuitry such as EMIC; and

FIG. 21 is a diagram for describing USB communication between the USB host controller and the optical link shown in FIG. 14, PD communication (or baseband communication) related to power supply and role determination between CC of the USB host controller and CC of the optical link, and PD communication encoded by biphase mark coding (BMC).

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. As used herein, the term “and/or” includes any and all combinations of one or more of the associated listed items. Expressions such as “at least one of,” when preceding a list of elements, modify the entire list of elements and do not modify the individual elements of the list.

Below, an optical link for providing a diagnosis and monitoring function according to an embodiment is described with reference to the accompanying drawings.

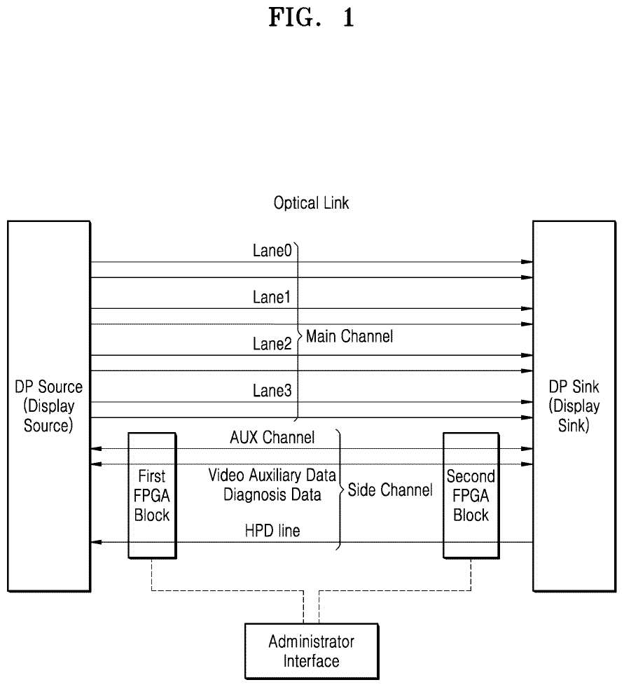

FIG. 1 shows a diagram for describing, according to an embodiment, a main channel for video data transmission in a display port (DP) to which an optical link for providing a diagnosis and monitoring function is applicable, and a side channel for transmitting video auxiliary data and diagnosis data.

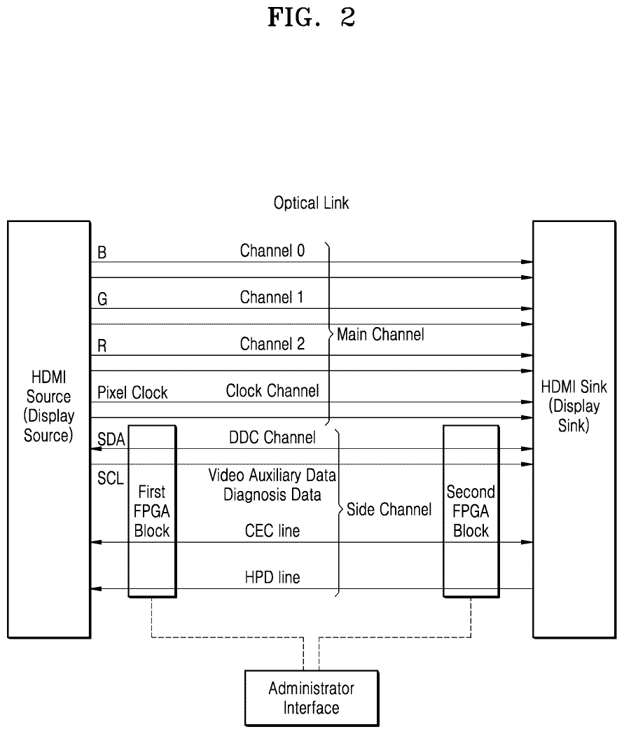

FIG. 2 shows a diagram for describing, according to an embodiment, a main channel for video data transmission in High-Definition Multimedia Interface (HDMI) to which an optical link for providing a diagnosis and monitoring function is applicable, and a side channel for transmitting video auxiliary data and diagnosis data.

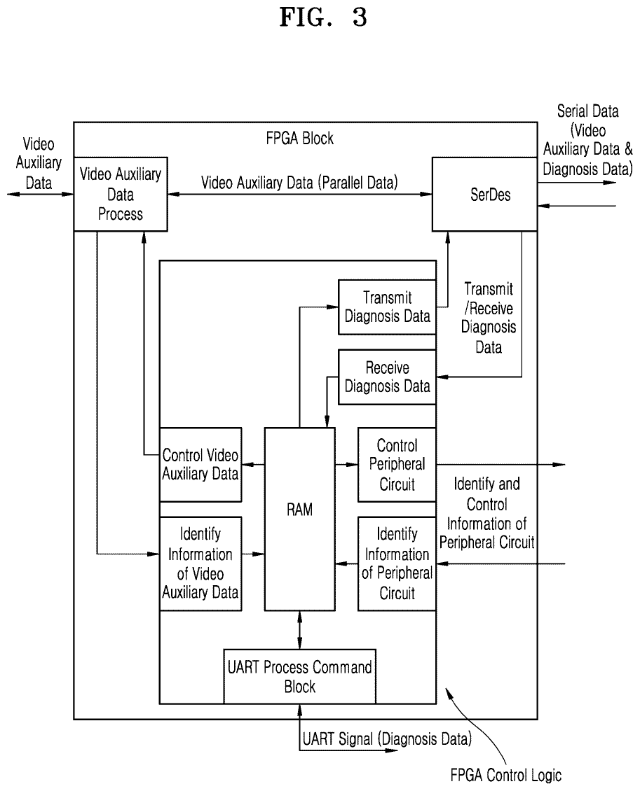

FIG. 3 is a diagram for describing a Field-Programmable Gate Array (FPGA) block shown in FIG. 1 or 2, in which are described: a configuration including an FPGA control logic in which a logic or process is configured to process video auxiliary data and diagnosis data, a memory (Random-Access Memory (RAM)) storing the video auxiliary data and diagnosis data processed from the FPGA control logic, and a Serializer +Deserializer (SerDes) for conversion between serial data and parallel data input to and output from the FPGA block; and a configuration of the FPGA block that includes a Universal Asynchronous Receiver-Transmitter (UART) communication channel formed between the FPGA block and a UART-to-Universal Serial Bus (USB) converter within an optical communication module, and a communication channel formed with a peripheral circuit for the generation of diagnosis data, including an operational status of an optical link, such as an operation temperature or an operation voltage.

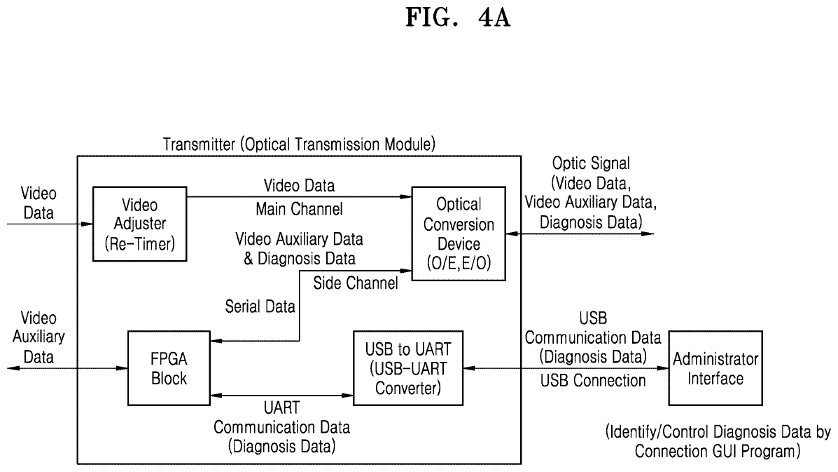

FIGS. 4A and 4B are diagrams for describing an optical communication module including the FPGA block shown in FIG. 3, showing an optical transmitter for video data transmission and an optical receiver for video data reception, respectively, wherein each of the optical transmitter and the optical receiver includes a re-timer connected on the main channel for video data transmission, and an FPGA block connected on the side channel for transmission of video auxiliary data and diagnosis data, a photoelectric conversion element connected to both of the main channel and the side channel, and a USB-to-UART converter formed on a data transmission channel between an administrator interface and the FPGA block connected through USB communication.

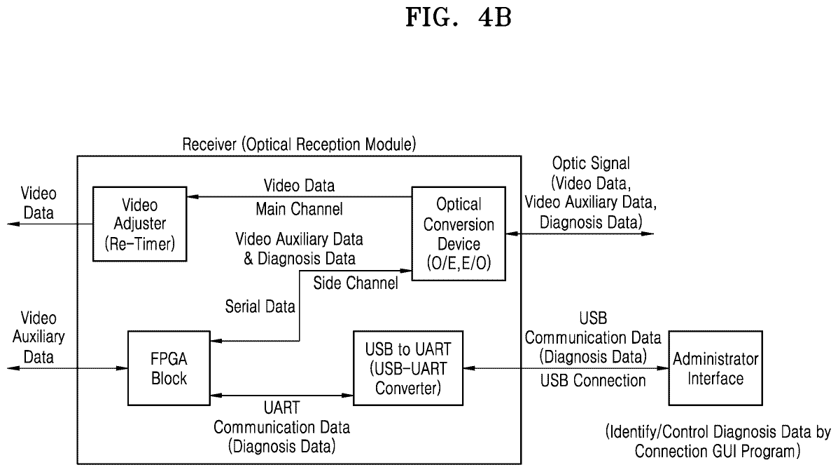

FIG. 5 is a diagram for describing the USB-to-UART converter of the optical transmitter and the optical receiver (optical communication module) respectively shown in FIGS. 4A and 4B, and shows a USB interface for converting, into UART communication data, USB communication data that is input from the administrator interface USB-connected to the optical transmitter and the optical receiver (optical communication channel), and a UART interface for converting UART communication data that is input from the FPGA block of the optical transmitter and the optical receiver into USB communication data.

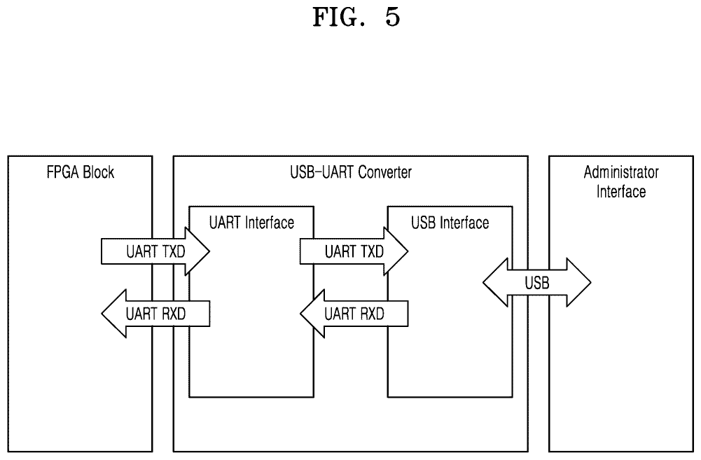

FIG. 6 shows a diagram for describing a memory structure that includes two different threads, a UART interface (for converting input UART communication data into USB communication data) and a USB interface (for converting input USB communication data into UART communication data), of a USB controller shown in FIG. 5, where an execution environment is provided within the same process where a code area (e.g., storing a function), a data area (e.g., storing a global variable), and a heap area (dynamic allocation memory) of a memory are shared while separately assigning a stack area (e.g., storing function parameters), in a process for providing an execution environment for the two threads.

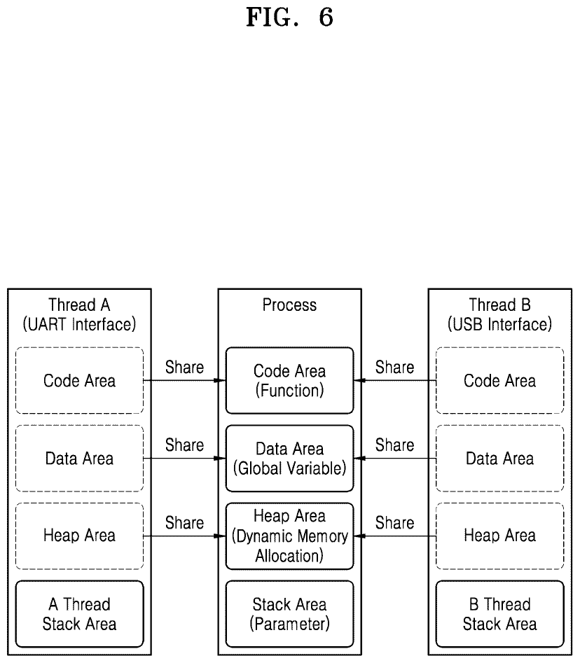

FIG. 7 shows a diagram for describing a case where, in the UART interface and the USB interface, which are the two different threads (thread A and thread B) shown in FIG. 6, where the execution environment is provided within the same process, main functions of the respective threads (thread A's main and thread B's main) and functions (add, minus, divide, and a plurality of) called from the main functions are stored in the code area in which they are shared with each other.

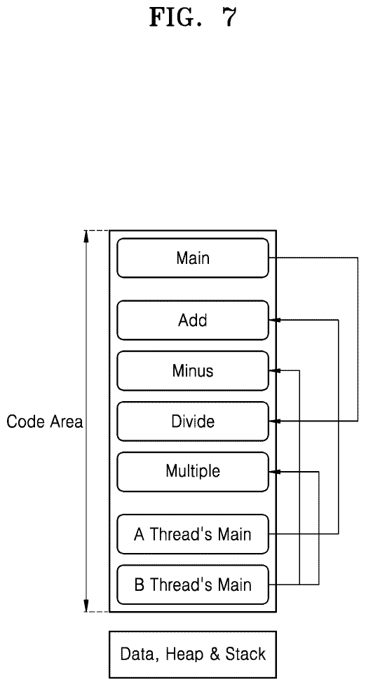

FIG. 8 is a diagram for describing Time-Division Multiplexing (TDM) of video auxiliary data and diagnosis data for the transmission of the video auxiliary data and the diagnosis data together, and shows the formation of a data frame in which the video auxiliary data and the diagnosis data are multiplexed through a time slot or sub-frame, which are obtained by TDM through a multiplexer from an input channel, or an input register connected thereto, storing the video auxiliary data and the diagnosis data, and the formation of a data frame of serial data from a Serializer +Deserializer (SerDes) to which a data frame of parallel data is input.

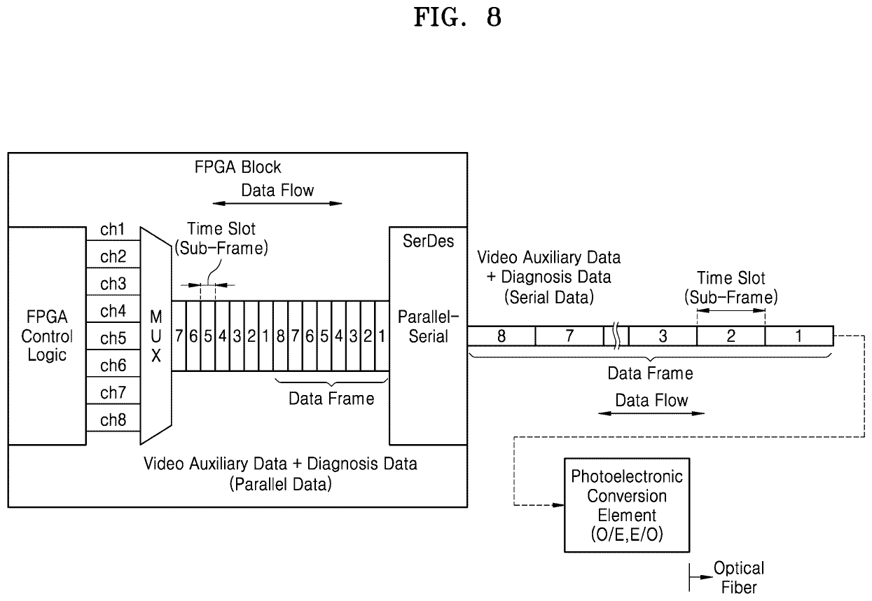

FIG. 9 is a diagram schematically illustrating a process flow of video auxiliary data and diagnosis data transmitted via a side channel, wherein an FPGA block includes an encoder/decoder that receives multiplexed video auxiliary data and diagnosis data output from a multiplexer (MUX), which is for multiplexing first to eighth input channels input from an input register of an FPGA control logic, and a SerDes for converting parallel data and serial data of the video auxiliary data and the diagnosis data to each other.

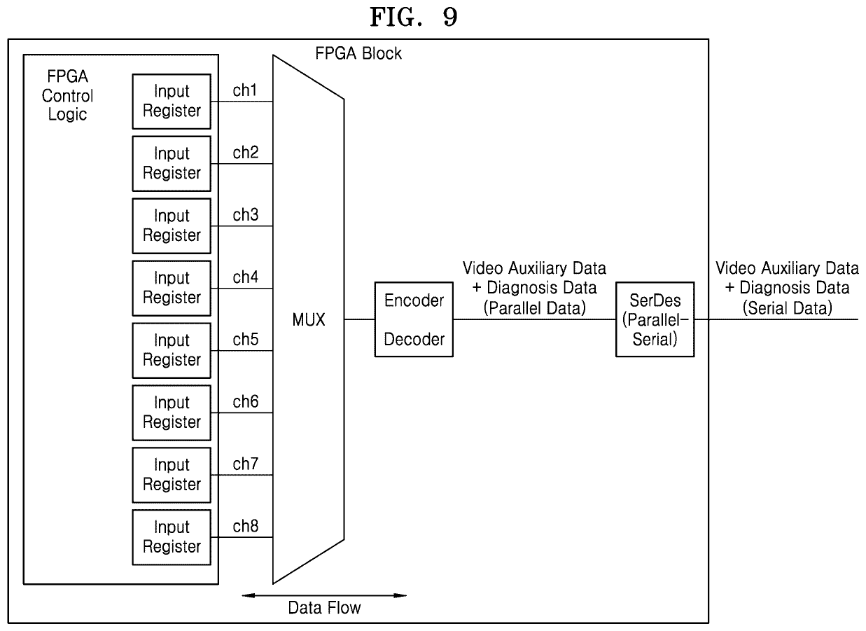

FIG. 10A is a diagram for describing Synchronous TDM (STDM) as an embodiment of TDM shown in FIG. 9.

FIG. 10B shows a diagram for describing an Asynchronous TDM (ATDM) compared to STDM shown in FIG. 10A.

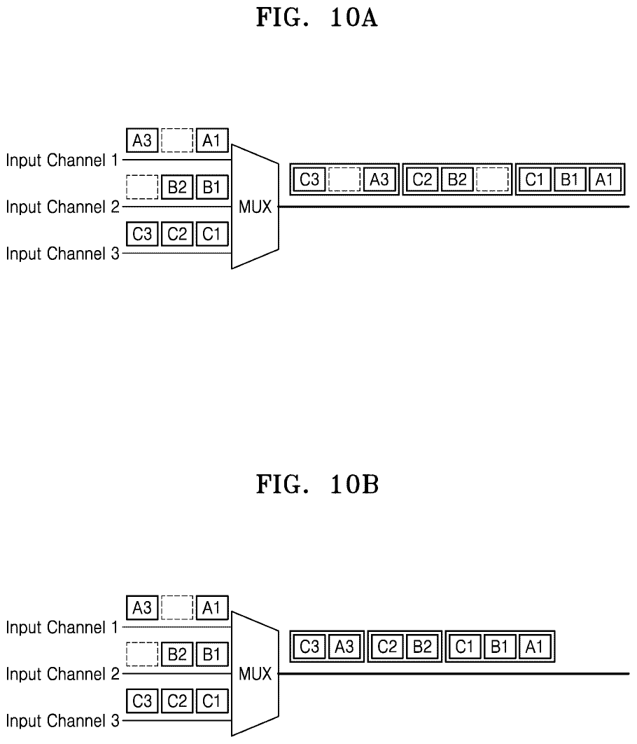

FIG. 11 is a diagram for describing a data frame of a non-diagnosis instance including only video auxiliary data rather than diagnosis data.

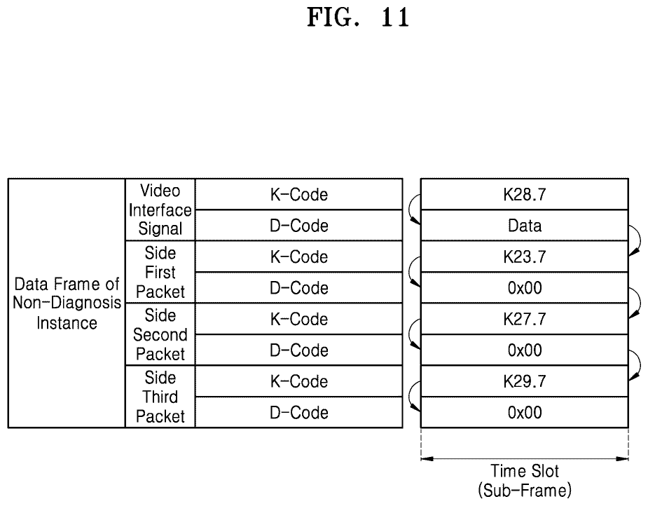

FIG. 12 is a diagram for describing a data frame of a diagnosis instance including diagnosis data together with video data.

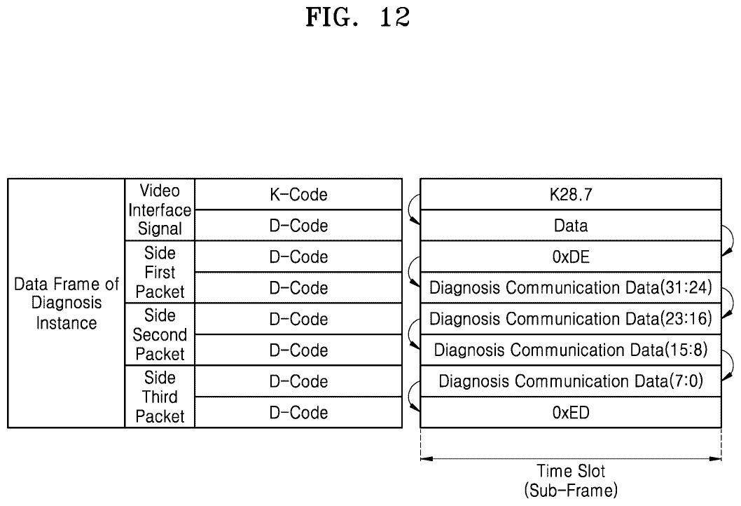

FIG. 13 is a diagram for describing an embodiment of STDM in which a stuffing symbol is filled in a time slot or sub-frame assigned to diagnosis data, in a data frame of a non-diagnosis instance without diagnosis data, and shows compatibility with an optical link to which a constant transmission capacity is assigned in a data frame not including diagnosis data.

An optical link for providing a diagnosis and monitoring function, according to an embodiment, may transmit video data and video auxiliary data, wherein the video data includes video information and is connected between a display source and a display sink, which constitute a system that supports HDMI (see FIG. 2) or a display port (DP) (see FIG. 1), and the video auxiliary data includes rendering configuration data such as extended display identification data (EDID) in relation to rendering of the display sink, and channel configuration data such as display port configuration data (DPCD) in relation to channel configuration of a main channel (or main lane) transmitting video data. By generating diagnosis data including status information of the optical link such as a connection status of the optical link, monitoring on the status information of the optical link may be provided.

An FPGA block may be connected to an optical link according to an embodiment, and the FPGA block may not be connected to the main channel (or main lane) transmitting the video data, and may be connected on a side channel (auxiliary channel or DDC channel) for transmitting video auxiliary data, which includes rendering configuration data such as EDID and channel configuration data such as DPCD, to be involved in overall management of the video auxiliary data, such as storage, change, and update of the video auxiliary data.

The FPGA block may include a first FPGA block connected adjacent to the side of the display source and a second FPGA block connected adjacent to the side of the display sink, and the main channel (or main lane) for transmission of video data including video information may be connected from the display source to the display sink without passing through the FPGA block.

For example, the FPGA block may be involved in overall management of video auxiliary data such as storage, change, and transmission of the video auxiliary data including rendering configuration data and channel configuration data, for example, by being involved in link training for main channel (or main lane) configuration so that the configuration of the main channel (or main lane) is optimized for the optical link, storing rendering configuration data such as EDID related to rendering of the display sink or channel configuration data such as DPCD for main channel (or main lane) configuration for transmission of video data, transmitting stored rendering configuration data or channel configuration data, or changing stored data.

In an embodiment, the FPGA block may be involved in management of diagnosis data, such as storage, change, and transmission of diagnosis data including status information of the optical link that, for example, may not be directly related to configuration of management of the main channel (or main lane) for transmitting image information, as video auxiliary data. For example, the FPGA block may be involved in management of diagnosis data such as storage, change, and transmission of diagnosis data for providing monitoring on the status information of the optical link, including the connection status of the optical link.

In an embodiment, the FPGA block may provide monitoring on video auxiliary data, which includes diagnosis data including status information of the optical link and channel configuration data and rendering configuration data of the main channel, through an administrator interface (FIGS. 1 and 2) and a data transmission channel for monitoring the connection status of the optical link. According to various embodiments, the administrator interface may comprehensively indicate a system (a system for implementing a diagnosis and monitoring on the optical link, hereinafter, “diagnosis and monitoring system”) connected in parallel to a plurality of optical links to provide a diagnosis and monitoring on the plurality of optical links, or a computing terminal individually connected to each optical link.

In an embodiment, the administrator interface (see FIGS. 1 and 2) may form a data transmission channel with at least any one FPGA block from among first and second FPGA blocks, which are connected adjacent to the side of the display source or the side of the display sink. For example, the administrator interface may obtain status information related to the optical link primarily related to the display source, such as a connection status between the optical link and the display source, which is connected adjacent to the first FPGA and connected to the first FPGA block connected adjacent to the side of the display source, or may obtain status information of the optical link primarily related to the display sink, such as a connection status between the optical link and the display sink, which is connected adjacent to the second FPGA and connected to the second FPGA block connected adjacent to the display sink.

In an embodiment, while being connected to each other through the optical link, the first FPGA block and the second FPGA block may communicate information about the connection status between the display source or display sink, which is connected adjacent to respective first and second FPGA blocks, and the optical link. Accordingly, through the connection with any one FPGA block from among the first and second FPGA blocks, status information (e.g., an operating temperature of a location adjacent to the display source, or the like) of the optical link primarily related to the display source, such as the connection status between each display source and the optical link, and status information (e.g., an operating temperature of a location adjacent to the display sink, or the like) of the optical link primarily related to the display sink, such as the connection status between the display sink and the optical link may all be obtained.

For example, in an embodiment, the administrator interface (see FIGS. 1 and 2) may be connected to the first FPGA block or the second FPGA block, and may receive information about a connection status (connection status between the display source and the optical link) on the side of the display source stored in the first FPGA block and about a connection status (connection status between the display sink and the optical link) on the side of the display sink stored in the second FPGA block received from a communication between the first and second FPGA blocks. In addition, the administrator interface may request update or change of data on the connection status stored in the first and second FPGA blocks based on data on the received connection status.

In an embodiment, the FPGA block may generate, store, update, and change video auxiliary data that includes channel configuration data related to configuration of a main channel (or main lane) such as DPCD transmitted from the side of the display source or the display sink and rendering configuration data related to rendering of the display sink such as EDID transmitted from the display sink, and diagnosis data that includes status information of the optical link such as a connection status between the optical link and the display source or display sink, an operational status (operational status such as an operating voltage or an operating temperature), and identification information of the optical link itself. The FPGA block may chronologically store latest data through update of data stored in the FPGA block in response to an environment change such as a change in configuration environment of the main channel (or main lane) or a change in connection status of the optical link.

The FPGA block (the first FPGA block or the second FPGA block (see FIG. 3)) may receive video auxiliary data received from the display source or display sink connected adjacent to the FPGA block or video auxiliary data received from the side of the display sink or display source on the opposite side to the optical link, and store or update the received video auxiliary data or read the video auxiliary data and process the video auxiliary data according to a pre-configured logic. For example, the FPGA block may read the video auxiliary data and change the video auxiliary data according to a pre-configured logic. In addition, for diagnosis data including status information of the optical link including a connection status with the optical link, the FPGA block (see FIG. 3) may receive a request (e.g., a read request or a write request) from the FPGA block (second FPGA block or first FPGA block) on the opposite side received through the optical link, store the diagnosis data in memory (RAM) of the FPGA block according to a logic defined in the FPGA block, receive and transmit the diagnosis data requested from the memory (RAM) of the FPGA block, update or change the diagnosis data stored in the memory (RAM) of the FPGA block, or process according to a pre-configured logic according to a request of the administrator interface connected through a data transmission channel with the FPGA block. For example, the FPGA block may receive the diagnosis data stored in the memory (RAM) thereof according to the request from the administrator interface and transmit the diagnosis data to the administrator interface, or may request diagnosis data to the FPGA block connected to the display sink and, in response to receiving the requested data, transmit the received data to the administrator interface.

In an embodiment, each logic set in the FPGA block (see FIG. 3) may be performed in parallel in an independent process or sequence, the diagnosis data for the connection status of the optical link may be stored in the memory (RAM) according to an independent logic or process, and the diagnosis data stored in the memory (RAM), according to the request from the administrator interface, may be called from the independent process and transmitted to the administrator interface (see FIGS. 1 and 2). As described above, in an embodiment, a logic or process configured in the FPGA block (see FIG. 3) may be performed in parallel with or independent of each other, and may implement a create, read, update, and delete (CRUD) operation or transmission operation for the memory of the FPGA block, thereby implementing processing or management of the diagnosis data.

In an embodiment, the FPGA block (see FIG. 3) may include a Serializer +Deserializer (SerDes) for converting input/output data of the FPGA block between parallel data and serial data. In an embodiment, the SerDes may convert serial data transmitted through the optical link into parallel data input to the FPGA block, and may convert parallel data transmitted from the FPGA block into serial data transmitted to the optical link. For example, in an embodiment, the SerDes may include a shift register for implementing a serializer (parallel to serial) for outputting, as serial data, parallel data of video auxiliary data input from the FPGA block according to a parallel clock. In addition, the SerDes may include a shift register for implementing a deserializer (serial to parallel) for sequentially receiving serial data of video auxiliary data transmitted through the optical link and outputting parallel data of the video auxiliary data according to a parallel clock.

In an embodiment, an optical communication module (see FIGS. 4A and 4B) may be connected between the display source and the display sink, and the optical communication module may include an optical transmitter (see FIG. 4A) connected on the side of the display source and an optical receiver (see FIG. 4B) connected on the side of the display sink. In addition, the optical communication module (see FIGS. 4A and 4B) may include the FPGA block described above (see FIG. 3), and may include, along with the FPGA block, a photoelectric conversion element for implementing photoelectric change between an electrical signal and an optic signal.

The photoelectric conversion element (see FIGS. 4A and 4B) is to implement a modulation between an electrical input/output signal and an optical input/output signal and convert an electrical signal into an optic signal, and may include a light-emitting element for transmitting an optic signal through an optical link (optical fiber of the optical link) and a light-receiving element for converting an optic signal received through the optical link (optical fiber of the optical link) into an electrical signal.

In an embodiment, connected on the main channel (or main line) for transmitting video data including video information are: a photoelectric conversion element (see FIGS. 4A and 4B) for implementing photoelectric conversion for video data; and a re-timer for ensuring stable signal transmission by compensating for latency of video data and latency caused along a transmission path of the video data. More specifically, the re-timer may receive video data on the side of the display source corresponding to the side of the transmission terminal and retransmit video data received on the side of the display sink corresponding to the reception terminal. In this case, the reproduction and readjustment of video data may be implemented to compensate for delay on the transmission path of data. For example, in an embodiment, the re-timer and the photoelectric conversion element may be connected together on the main channel (or main lane), which is responsible for transmission of video data, in the optical communication channel for transmission of video data.

In an embodiment, the re-timer and the photoelectric conversion element may be connected on the main channel (main lane), which is responsible for transmission of video data, on the data transmission channel of the optical communication module (see FIGS. 4A and 4B), and the FPGA block described above and the photoelectric conversion element connected on the main channel (or main lane) may be connected together on a side channel (auxiliary channel or DDC channel) responsible for transmission of video auxiliary data and diagnosis data. In other words, the photoelectric conversion element of the optical communication module (see FIGS. 4A and 4B) may be connected together on the main channel (or main lane) responsible for transmission of video data and on the side channel (auxiliary channel or DDC channel) responsible for transmission of video auxiliary data and diagnosis data. For example, video data output from the re-timer and video auxiliary data and diagnosis data output from the FPGA block may be modulated together from an electrical signal from the photoelectric conversion element to an electric signal. As described below, an optical link for providing a diagnosis and monitoring function, according to an embodiment, may generate a data frame for transmitting video auxiliary data and diagnosis data together through the side channel from TDM (see FIG. 8) so that the video auxiliary data and the diagnosis data including status information of the optical link may be transmitted together through the side channel. For example, video auxiliary data and diagnosis data multiplexed into one data frame through TDM (see FIG. 8) from the FPGA block may be converted from an electrical signal to an optic signal through the photoelectric conversion element (see FIGS. 4A and 4B).

Similarly, an optic signal for video data transmitted from an optical link may be converted from a photoelectric conversion element (see FIGS. 4A and 4B) into an electrical signal, processed to reproduce or readjust video data through the re-timer, and then transmitted to the display sink through a conductive line capable of communicating an electrical signal. In addition, an optic signal for video auxiliary data and diagnosis data transmitted from the optical link may be converted from a photoelectric conversion element into an electrical signal and input to the FPGA block, and the video auxiliary data and the diagnosis data input to the FPGA block (see FIG. 3) may be stored in the memory (RAM) of the FPGA block, may update data stored in the memory (RAM) of the FPGA block, may be changed according to a logic or process preconfigured in the FPGA block, or may be transmitted to the outside of the FPGA block (an administrator interface (see FIGS. 1 and 2) connected to a USB port of the optical communication module including the FPGA block, as described below) according to a preconfigured logic or process.

As described above, the re-timer and the photoelectric conversion element may be connected on the main channel (main lane), which is responsible for transmission of video data, on the data transmission channel of the optical communication module (see FIGS. 4A and 4B), and the FPGA block and the photoelectric conversion element may be connected on a side channel (auxiliary channel or DDC channel) responsible for transmission of video auxiliary data and diagnosis data. Meanwhile, the USB-to-UART converter may be connected on the data transmission channel between the optical communication module (see FIGS. 4A and 4B) and the administrator interface (see FIGS. 1 and 2) connected to the USB port of the optical communication module. For example, in an embodiment, the optical communication module (see FIGS. 4A and 4B) may include the USB-to-UART converter connected between the FPGA block and the USB port. In an embodiment, UART communication data transmitted from the FPGA block through the USB-to-UART converter (see FIGS. 4A and 4B) may be converted into USB communication data and transmitted to an administrator interface connected to the FPGA block through the data transmission channel (e.g., an administrator interface USB-connected to an optical communication module including an FPGA block (see FIGS. 1 and 2). Reversely, USB communication data transmitted from the administrator interface USB-connected through the USB-to-UART converter (see FIGS. 4A and 4B) may be converted into UART communication data and transmitted to the FPGA block.

The USB-to-UART converter (see FIGS. 4A and 4B) may readjust, to a data structure, control information, and timing following a UART communication protocol, data following a USB communication protocol, a data structure, such as a format, coding, a signal level, or a sequence, of data following a USB communication protocol, control information such as interpretation of the corresponding signal pattern and transmission control and error correction according to the interpretation, and a timing such as speed adjustment between communication hosts, a transmission time of a message, and a transmission order. Reversely, a data structure, control information, and timing following the UART communication protocol may be readjusted to a data structure, control information, and timing following the USB communication protocol. For example, the USB-to-UART converter (see FIGS. 4A and 4B) may perform a process for readjusting a data structure, control information, and timing between different communication protocols.

For example, the USB-to-UART converter (see FIGS. 4A and 4B) may generate and execute two different threads in which an execution environment is provided within the same process and which each include a main function (see FIG. 5). In a process of providing the execution environment of the two different threads, the two different threads may share a code area, a data area, and a heap area of the memory while a stack area may be individually assigned for each thread (see FIGS. 6 and 7).

In other words, the optical communication module (see FIGS. 4A and 4B) may include the USB-to-UART converter connected between the FPGA block and a USB port, and he TSB-to-UART converter may include a USB interface (see FIG. 5) as a thread that is executed to convert USB communication data transmitted from an administrator interface connected to the USB port into UART communication data transmitted toward the FPGA block, and UART interface (see FIG. 5) as a thread that is executed to convert UART communication data transmitted from the FPGA block into USB communication data transmitted toward an administrator interface connected to the USB port.

That is, the USB-to-UART converter (see FIG. 5) may generate and execute two different threads in which an execution environment is provided within the same process and which each include a main function. Each of the two different threads may include a thread (USB interface) for converting USB communication data into UART communication data following the UART communication protocol, and a thread (UART interface) for converting UART communication data following the UART communication protocol into USB communication data following the USB communication protocol. For example, these different threads may be executed independently of each other, and each thread for USB-UART conversion may convert USB communication data or UART communication data input to the USB-UART converter (see FIG. 5) into UART communication data or USB communication data as a unit (e.g., a data frame unit) in which error detection or error correction is defined or as a series of consecutive data transmitted from one side to the other between communication hosts as a whole. When USB-UART conversion is performed in the middle of the unit (e.g., a data frame unit) in which error detection or error correction is defined or as a series of consecutive data transmitted from one side to the other between the communication hosts, the converted data may include an error prior to the error detection or error correction in the USB communication data or the UART communication data and transmitted to the next step, and thus the USB-UART communication may be performed as a unit (e.g., a data frame unit or a series of consecutive4 signals as a whole) in which at least error detection or error correction is possible.

In other words, the USB interface and the UART interface (see FIG. 5) may execute the USB-UART conversion after transmission is completed up to the last byte as a series of consecutive data, as a whole, transmitted from one side to the other between a USB-UART converter and an administrator interface connected to the USB port, or after transmission is completed up to the last byte as a series of consecutive data, as a whole, transmitted from one side to the other between the FPGA block and the USB-UART converter.

In an embodiment, the USB-UART converter (see FIG. 5) may convert USB communication data into UART communication data following a UART protocol, which is asynchronous serial communication, no separate clock signal may be involved, and data may be read from a baud rate prescribed by the UART protocol, a start bit (e.g., bit 0), and a stop bit (e.g., bit 1). For example, in an embodiment, a UART communication channel on which the UART communication data is transmitted may be configured with a baud rate of 115200 bps, a data bit of 8 bits, a non-parity bit, and one stop bit.

In an embodiment, the optical link may include an optical communication module (see FIGS. 4A and 4B) including an FPGA block. The optical communication module may include an optical transmitter forming the side of a transmission terminal and an optical receiver forming the side of a reception terminal. Here, the transmission terminal and the reception terminal may respectively indicate the side of a display source transmitting video data and the side of a display sink receiving video data. For example, the video data may form a monodirectional data flow from the display source side toward the display sink side. Unlike this video data, the video auxiliary data and diagnosis data may form a bidirectional data flow between the display source side and the display sink side. For example, a side channel (auxiliary channel or DDC channel) responsible for transmission of video auxiliary data and diagnosis data may support bidirectional communication of a data flow in one direction from the display source toward the display sink and a data flow in the reverse direction from the display sink toward the display source.

In an embodiment, the optical transmitter (see FIG. 4A) connected on the display source side and the optical receiver connected on the display sink side may include substantially the same configuration. However, main channels (or main lane) responsible for transmission of video data in the respective optical transmitter and optical receiver may transmit or receive flow of video data in opposite directions from each other.

In an embodiment, a conductive line accommodating a flow of electric signals may be formed between the optical transmitter (see FIG. 4A) and a display source forming one terminal of the optical link, and a conductive line accommodating the flow of electrical signals may also be formed between the optical receiver (see FIG. 4B) and the display sink forming the other terminal of the optical link. In this case, an optical fiber accommodating the flow of optic signals may be formed between the optical transmitter and the optical receiver.

In an embodiment, the FPGA block (see FIG. 3) may be involved in overall management of diagnosis data, such as generation, storage, update, and transmission of the diagnosis data, which includes status information of an optical link including at least one of a connection status of the optical link, an operational status (operating temperature and operating voltage) of the optical link, and identification information of the optical link itself. For example, the administrator interface (see FIGS. 1 and 2) may form a host of USB connection while forming USB connection with the FPGA block, and the FPGA block may form a device of USB connection. For example, the FPGA block, as a host connected through a USB port, may perform data communication for receiving diagnosis data and/or video auxiliary data through USB connection with the administrator interface and transmitting the requested diagnosis data and/or video auxiliary data. For example, USB communication data received from the administrator interface may be converted into UART communication data through the USB-UART converter (see FIGS. 4A and 4B), the converted UART communication data may be input to the FPGA block (see FIG. 3) and converted from serial data of the UART communication data into parallel data through a SerDes of the FPGA block, and the converted parallel data, according to a logic or process configured in the FPGA block, may perform a configured operation, such as reading data from the memory (RAM) or writing data on the memory (RAM) or transmitting diagnosis data and/or video auxiliary data stored in the memory (RAM) to the administrator interface. For example, according to a logic or process called according to a request received from the administrator interface, video auxiliary data including diagnosis data and/or channel configuration data, and rendering configuration data may be received and transmitted to the administrator interface, the diagnosis data including information stored in the memory (RAM) of the FPGA block, such as at least one of a connection status of the optical link stored in the memory (RAM), an operational status (operating temperature and operating voltage) of the optical link, and identification information of the optical link itself.

In an embodiment, the diagnosis data including at least one of the connection status of the optical link, the operational status of the optical link, the identification information of the optical link itself may be stored in the memory (RAM) of the FPGA block (see FIG. 3), and diagnosis data stored in the memory (RAM) of the FPGA block may be transmitted according to a request (control command) from the administrator interface connected to the USB port of the FPGA block. For example, the memory of the FPGA block may store diagnosis data including status information primarily related to a display sink or a display source, such as a connection status between an optical link and the display sink or display source connected on opposite side to the optical link, together with diagnosis data including status information primarily related to a display source or a display sink, such as a connection status between the optical link and a display source or display sink connected adjacent to the FPGA block itself. For example, according to data communication between a first FPGA block connected on the display source side and a second FPGA block connected on the display sink side, the administrator interface may receive diagnosis data including status information primarily related to the display source, such as the connection status between the display source and the optical link, together with diagnosis data including status information primarily related to the display sink, such as the connection status between the display sink and the optical link, through the first FPGA block (e.g., an optical transmitter including the first FPGA block) or the second FPGA block (e.g., an optical receiver including the second FPGA block) that may be selectively connected from among the first and second FPGA blocks. For example, the first and second FPGA blocks may receive diagnosis data through data communication between the first and second FPGA blocks at periodically configured time intervals and store the received diagnosis data, the diagnosis data including status information primarily related to the display sink or the display source, which are connected on opposite sides, such as the connection status between the optical link and the display sink or the display source, which are on opposite sides. In addition, the diagnosis data stored in the memory of the first and second FPGA blocks may be updated or changed to latest data.

In various embodiments, the memory (RAM) of the FPGA block (see FIG. 3) may store diagnosis data related to the display source or sink, such as the connection status with the display source or sink connected adjacent to the corresponding FPGA block, and also diagnosis data related to the display sink or display source, such as the connection status with the display sink or display source far from the corresponding FPGA block. At this time, the interface may acquire all diagnosis data that includes status information of the optical link related to the display source and/or display sink, such as the connection status between the display source and the display sink and the optical link that forms both ends of the optical link connection, from the first FPGA block (e.g., an optical transmitter including the first FPGA block, see FIG. 4A) or the second FPGA block (e.g., an optical receiver including the second FPGA block, see FIG. 4B) which is selectively connected from among the first and second FPGA blocks. The diagnosis data including status information related to the display source and display sink, including the connection status of the display source and display sink with the optical link, which is stored in the memory (RAM, see FIG. 3) of each of the first or second FPGA blocks, may be transmitted upon the request (control command) of the administrator interface. In various embodiments, the first and second FPGA blocks (see FIG. 3) may also generate diagnosis data and transmit the generated data upon a request from the administrator interface connected via USB. For example, a process or logic set in the first and second FPGA blocks (see FIG. 3) may be called in response to a request (control command) from the administrator interface. This may either generate diagnosis data primarily related to the display source or sink (including other status information of the optical link), such as the connection status between the FPGA block's own connected display source or sink and the optical link, or it may request diagnosis data from the other FPGA block connected via the optical link. This requested data would primarily be related to the display sink or display source on the opposite side of the optical link (including other status information of the optical link), such as its connection status with the optical link.

In an embodiment, the video auxiliary data and diagnosis data may be transmitted through the same side channel (auxiliary channel or DDC channel). The data frame transmitted through the side channel may include time-division multiplexed (TDM) time slots or sub-frames (see FIGS. 8 and 9). By using these time-division multiplexed time slots or sub-frames, a single side channel is multiplexed into a plurality of channels, allowing different types of video auxiliary data and diagnosis data to be transmitted together through that single side channel. In an embodiment, the data frame of the side channel may be multiplexed in 8-bit units via 8-bit time slots or sub-frames. More specifically, in an embodiment, the data frame transmitted through the side channel may include a special code area and a data area that are transmitted in time-division multiplexed time slots or sub-frames (see FIGS. 8 and 9). More specifically, the data frame, which is assigned to alternating, time-division multiplexed time slots or sub-frames, may include a special code area (K-CODE), where a special code (or special character) is assigned as a control symbol, and a data area (D-CODE) (see FIGS. 11 and 12).

In an embodiment, the special code area (K-CODE) (see FIGS. 11 and 12) may refer to the remaining sections of the data frame excluding the data area (D-CODE). The K-CODE may include control information for each section of the data frame, for example, the time slots or sub-frames (see FIGS. 8 and 9), based on a predefined rule among the communication hosts (the display source, the first FPGA block connected to the display source, the display sink, or the second FPGA block connected to the display sink). For example, just as special codes like BS (blanking start) and BE (blanking end) express the start or end of a blanking period on a data frame containing video data, the K-CODE on a side channel data frame containing video auxiliary data and diagnosis data may also include control information for each section of the data frame, such as the data frame's time slots or sub-frames.

In an embodiment, the data frame of the side channel (see FIGS. 11 and 12), which includes the video auxiliary data and diagnosis data, may have a structure where a special code area (K-CODE, special code, special character) corresponding to a control symbol and a data area (D-CODE) are assigned to different time slots or sub-frames along the time axis. For example, a single data frame may have a total transmission capacity of 64 bits, including 8 units of 8-bit time slots or sub-frames. In an embodiment, for diagnosis data and video auxiliary data to be transmitted together through a single side channel, the data frame (see FIGS. 11 and 12) from time-division multiplexing (see FIGS. 8 and 9) may have a structure where a special code area (K-CODE) and a data area (D-CODE), each 1 byte in size, are alternately assigned. In an embodiment, the data frame of a non-diagnosis instance side channel (see FIG. 11), which includes video auxiliary data but not diagnosis data, may have a structure where the special code area (special code, special character, K-CODE) and the data area (D-CODE) are alternately assigned, as described above. In contrast, the data frame of a diagnosis instance side channel (see FIG. 12), which includes both video auxiliary data and diagnosis data, may have a different data frame structure than that of the non-diagnosis instance side channel (see FIG. 11). As described above, the data frame for a non-diagnosis instance side channel (see FIG. 11) may have a structure where a special code area (special code, special character, K-CODE) and a data area (D-CODE) are alternately assigned. In contrast, the data frame for a diagnosis instance side channel (see FIG. 12) may have the special code area and data area alternately assigned within the Video Interface Signal segment at the start of the frame. However, in the subsequent segments, the Side First, Side Second, and Side Third packet segments, only the data area (D-CODE) is assigned, without the special code area (K-CODE). In an embodiment, for the data frame of a diagnosis instance side channel (see FIG. 11) where diagnosis data exists, only the special code area (K-CODE) representing the start of the data frame may be assigned. The other segments, specifically the Side First, Side Second, and Side Third packet segments, which follow the Video Interface Signal segment at the start of the data frame, may contain only a data area (D-CODE) without the special code area (K-CODE). For example, the diagnosis data start symbol (0xDE) and diagnosis data end symbol (0xED), which function as control symbols (or control information) to indicate the start and end of the Side First, Side Second, and Side Third packet segments forming the data area (D-CODE), may function as control symbols (or control information) in an embodiment. However, considering the convenience of the process for data frame generation, and for instance, by assigning the entire section of the Side First, Side Second, and Side Third packet segments following the Video Interface Signal segment at the start of the data frame as a data area (D-CODE, diagnosis data) with the special code area (K-CODE) excluded, the diagnosis data start symbol (0xDE) and the diagnosis data end symbol (0xED) that express the start and end of the diagnosis data may be treated the same as the generation of the diagnosis data payload assigned between them. For example, the entire section from the diagnosis data start symbol (including it) to the diagnosis data end symbol (including it) may be processed as a data area. Essentially, the diagnosis data start symbol and the diagnosis data end symbol, intended to represent the start and end of the diagnosis data, respectively, may be assigned to a data area that may be changed or modified, allowing communication hosts (e.g., the display source, the first FPGA block on the display source side, the display sink, or the second FPGA block on the display sink side) to set autonomous communication rules regarding the start and end of the diagnosis data.

In an embodiment, the video auxiliary data is information related to video data transmitted through the main channel (or main lane), such as main channel configuration information (e.g., DPCD) or rendering configuration information (e.g., EDID). This data may undergo a high number of communications, including requests and replies, over a short time interval, unlike diagnosis data, which includes optical link status information such as the connection status between the display source or display sink, the operating status of the optical link (e.g., operating voltage, operating temperature), or the optical link's own identification information. For example, during channel equalization for the main channel (or main lane) setup, a high number of communications is required between the display source and the display sink, such as requests and replies for: setting and changing a training pattern; changing the main channel (or main lane) settings; and information related to the success or failure of the channel equalization. The requests for data and replies to those requests for channel equalization, which is for setting up the main channel (or main lane), may be transmitted as video auxiliary data through a side channel (auxiliary channel or DDC channel).

In an embodiment, both video auxiliary data and diagnosis data may be transmitted through a side channel (auxiliary channel or DDC channel). As described above, video auxiliary data needs to support a relatively high number of communications or a large amount of traffic, such as data requests and replies to those requests. In contrast, diagnosis data, which includes status information like the connection status between the display source or sink and the optical link, the operational status of the optical link (e.g., operating voltage, operating temperature), and the optical link's own identification information, may be sufficient with a relatively low number of communications or a small amount of traffic for data requests and replies. For instance, the communication traffic for video auxiliary data, involving data requests and replies transmitted through the side channel, and the communication traffic for diagnosis data concerning the connection status of the optical link between the display source and the display sink may be set to different numbers of communications or different amounts of traffic. Considering this communication traffic imbalance between video auxiliary data and diagnosis data, an embodiment may consider: 1) a data frame structure that includes only video auxiliary data (data frame structure for a non-diagnosis instance of the side channel, see FIG. 11); and 2) a data frame structure that includes both video auxiliary data and diagnosis data (data frame structure for a diagnosis instance of the side channel, see FIG. 12).

In an embodiment, a data frame (see FIGS. 11 and 12) for time-division multiplexing (TDM) different types of video auxiliary data and diagnosis data may include video auxiliary data. Based on the presence of diagnosis data, it may form: a data frame where the data area assigned for diagnosis data is filled with the diagnosis data itself, when the data is present; and a “stuffed data frame” where the data area assigned for diagnosis data is filled with a preset stuffing symbol (0x00), when the diagnosis data is not present. Accordingly, the data frame structure of a non-diagnosis instance where diagnosis data is not present (see FIG. 11) may have a pattern where the special code area (K-CODE) and the data area (D-CODE) are alternately repeated. For example, in an embodiment, the data frame (see FIGS. 11 and 12) may include time-division multiplexed 8-unit time slots or sub-frames (see FIGS. 8 and 9). Each of the 8 input channels may be multiplexed by assigning each input channel to a respective unit time slot or sub-frame. In an embodiment, an optical link for providing a diagnosis and monitoring function may include eight input channels (CH1 to CH8) that are multiplexed via time-division multiplexing (TDM, see FIGS. 8 and 9), and a multiplexer (MUX) that selects and outputs the input channel assigned to the current time slot or sub-frame based on a control signal. The multiplexer may output any one of the eight selected input channels.

In an embodiment, in a data frame for a non-diagnosis instance (see FIG. 11) where only video auxiliary data exists, the eight input channels (see FIGS. 8 and 9) or the input registers connected to them may store: an 8-bit special code for the special code area; 8-bit video auxiliary data for the data area assigned to it; and an 8-bit stuffing symbol (e.g., 0x00) to fill the data area assigned for diagnosis data. In contrast, in a data frame for a diagnosis instance (see FIG. 12) where both video auxiliary data and diagnosis data are present, the eight input channels (see FIGS. 8 and 9) or the connected input registers may store: an 8-bit special code for the Video Interface Signal segment at the frame's start; 8-bit video auxiliary data for its assigned data area; and 8-bit diagnosis data (including the diagnosis data start symbol 0xDE and end symbol 0xED) for its assigned data area.

In an embodiment, the multiplexer (see FIGS. 8 and 9) may implement stuffing by not filling the time slot or sub-frame assigned for diagnosis data with video auxiliary data, even when diagnosis data is not present in the input channel assigned for it. Instead, it fills the frame area assigned for the absent diagnosis data with a stuffing symbol (e.g., 0x00). This multiplexing of different video auxiliary data and diagnosis data corresponds to Synchronous Time Division Multiplexing (STDM, see FIG. 10A). In STDM, even when an input channel has no data, the time slot assigned to that channel for TDM is not filled with data from another input channel. This is in contrast to Asynchronous Time Division Multiplexing (ATDM, see FIG. 10B), where an empty time slot of one channel is filled with data from another channel.

In an embodiment, the implementation of Synchronous Time Division Multiplexing (STDM, see FIG. 10A), where the data area (D-CODE) assigned for diagnosis data in a non-diagnosis instance data frame (see FIG. 11) is filled with a stuffing symbol (0x00) instead of assigned to other input channels (e.g., video auxiliary data), serves to maintain the side channel's data frame at a constant data size (8 bytes, 64 bits) regardless of the presence of diagnosis data. This also provides compatibility with optical links that transmit only video auxiliary data and not diagnosis data through the side channel. In an embodiment, a comparative example (see FIG. 13) of an optical link's side channel may transmit only video auxiliary data without diagnosis data. In this case, the 8-bit parallel video auxiliary data may be transmitted through the side channel as a data frame with a fixed size of 32 bits, after undergoing 1b4b coding. To ensure compatibility with such optical links that maintain a fixed-size data frame, an embodiment implements Synchronous Time-Division Multiplexing (STDM, see FIG. 10A) to multiplex video auxiliary data and diagnosis data (see FIGS. 8 and 9). In this implementation, for a non-diagnosis instance data frame (see FIG. 11) where diagnosis data is not present, the data area (D-CODE) assigned for diagnosis data is not assigned to other input channels (e.g., video auxiliary data) but is filled with a stuffing symbol (0x00). For example, in an embodiment, the data frame (see FIGS. 11 and 12) for implementing time-division multiplexing between video auxiliary data and diagnosis data may include 8-unit time slots or sub-frames. Each of these 8-unit time slots or sub-frames may be assigned as 8 bits (1 byte) each, forming a data frame with a total transmission capacity of 64 bits (8 bytes), which may maintain a constant transmission capacity regardless of the presence of diagnosis data.

In an embodiment, the description of the data frame for a non-diagnosis instance (see FIG. 11), which includes only video auxiliary data and not diagnosis data, and the data frame for a diagnosis instance (see FIG. 12), which includes both video auxiliary data and diagnosis data, is as follows.

A data frame that includes only video auxiliary data (a data frame for a non-diagnosis instance, see FIG. 11) may have a structure where a special code area (K-CODE), to which a special code is assigned, and a data area (D-CODE) are alternately assigned. Each of the special code area (K-CODE) and the data area (D-CODE) may be assigned an 8-bit (1-byte) transmission capacity. At this time, the D-CODE following the special code area (K-CODE, e.g., K28.7) that represents the start of the data frame along the time axis may be assigned with video auxiliary data. The subsequently alternating D-CODEs following the special code areas (K-CODE, e.g., K23.7, K27.7, K29.7) may be filled with a stuffing symbol (0x00) (see Synchronous Time Division Multiplexing, FIG. 10A). In an embodiment, the data frame of the side channel (see FIGS. 11 and 12) may include the Video Interface Signal segment (including a 1-byte special code area K-CODE and a 1-byte data area D-CODE), the Side First packet segment (including a 1-byte special code area K-CODE and a 1-byte data area D-CODE), the Side Second packet segment (including a 1-byte special code area K-CODE and a 1-byte data area D-CODE), and the Side Third packet segment (including a 1-byte special code area K-CODE and a 1-byte data area D-CODE). In an embodiment, both video auxiliary data and diagnosis data may be transmitted via a side channel (auxiliary channel or DDC channel). The data frame of this side channel, which includes both video auxiliary data and diagnosis data, may include a Video Interface Signal segment at the start of the frame and a Side Third packet segment at the end of the frame, as well as a Side First packet segment and a Side Second packet segment interposed between the frame's start and end segments. In addition, the segments that form the data frame (Video Interface Signal, Side First packet, Side Second packet, Side Third packet) may each include a special code area (K-CODE) and a data area (D-CODE), each assigned 1 byte. Here, the Video Interface Signal segment at the start of the data frame (more specifically, the D-CODE of the Video Interface Signal segment) may be assigned with video auxiliary data. The subsequent Side First packet, Side Second packet, and Side Third packet segments (the D-CODEs of the Side First, Side Second, and Side Third packet segments) may be assigned with diagnosis data. In the data frame for a non-diagnosis instance (see FIG. 11) where diagnosis data is not present, the D-CODEs of the Side First, Side Second, and Side Third packet segments may be filled with a stuffing symbol (0x00). In the data frame for a diagnosis instance (see FIG. 12) where diagnosis data is present, the D-CODEs of the Side First, Side Second, and Side Third packet segments may be filled with diagnosis data.

In various embodiments, in a data frame for a non-diagnosis instance (see FIG. 11) where diagnosis data is not present, the special code area (K-CODE) and the data area (D-CODE) may be alternately assigned. In a data frame for a diagnosis instance (see FIG. 12) where diagnosis data is present, the Video Interface Signal segment at the beginning of the data frame may include a special code area (K-CODE) representing the start of the data frame and a data area (D-CODE) assigned for video auxiliary data, similar to the non-diagnosis instance data frame (see FIG. 11). However, the other subsequent segments, the Side First, Side Second, and Side Third packet segments, may be assigned only the data area (D-CODE) without the special code area (K-CODE). Among the data areas (D-CODEs) of these segments, the leading data area of the Side First packet segment and the trailing data area of the Side Third packet segment may be respectively assigned to a diagnosis data start symbol (0xDE) and a diagnosis data end symbol (0xED), which signal the start and end of the diagnosis data. Unlike the special code area (K-CODE), the diagnosis data start and end symbols may be configured or modified according to autonomous rules between the communication hosts (e.g., the first FPGA block on the display source side and the second FPGA block on the display sink side). For example, a diagnosis instance data frame (see FIG. 12), which includes diagnosis data, may, similarly to the non-diagnosis instance data frame (see FIG. 11), include a special code area (K-CODE) and a data area (D-CODE), each 1 byte (8 bits). The special code area and data area of the Video Interface Signal segment may each be assigned 1 byte. The subsequent Side First packet, Side Second packet, and Side Third packet segments may be assigned only a data area (D-CODE) without a special code area (K-CODE), with each data area (D-CODE) being assigned 1 byte (8 bits). As described above, the leading data area (1 byte, 8 bits) at the start of the Side First packet segment and the trailing data area (1 byte, 8 bits) at the end of the Side Third packet segment may be assigned the diagnosis data start symbol (0xDE) and the diagnosis data end symbol (0xED), respectively. The remaining data areas (1 byte, 8 bits) may be assigned the actual diagnosis data.

In other words, concerning the data frames (see FIGS. 11 and 12) for time-division multiplexing (TDM, see FIGS. 8 and 9) of different video auxiliary data and diagnosis data, depending on the presence of diagnosis data: a data frame for a non-diagnosis instance (see FIG. 11), where diagnosis data is not present, may include a special code area and a data area that are alternately assigned within the 8-unit time slots or sub-frames; and a data frame for a diagnosis instance (see FIG. 12), where diagnosis data is present, may include a sequence of a special code area assigned to the time slot or sub-frame of the unit corresponding to the start of the data frame, and a sequence of data areas assigned to the remaining time slots or sub-frames of the other units following the unit with the special code area along the time axis.

More specifically, the data frame for a non-diagnosis instance (see FIG. 11) and the data frame for a diagnosis instance (see FIG. 12) may both commonly include a Video Interface Signal segment at the start of the data frame and Side First packet, Side Second packet, and Side Third packet segments that follow the Video Interface Signal segment along the time axis. The Video Interface Signal segment may include a special code area and a data area. The special code area of the Video Interface Signal segment may be assigned with a special code that indicates the start of the data frame, and the data area of the Video Interface Signal segment may be assigned with video auxiliary data.

For example, each of the Side First packet, Side Second packet, and Side Third packet segments of the non-diagnosis instance data frame (see FIG. 11) may include a special code area and a data area. The data areas of the Side First, Side Second, and Side Third packet segments may be filled with a stuffing symbol in place of the non-existent diagnosis data.

For example, in the data frame of a diagnosis instance (see FIG. 12), each of the Side First packet, Side Second packet, and Side Third packet segments may include 2-unit time slots or sub-frames, which precede and follow one another along the time axis. The preceding time slot of the Side First packet may be filled with a diagnosis data start symbol, and the trailing time slot of the Side Third packet may be filled with a diagnosis data end symbol. The data between the trailing time slot of the Side First packet and the preceding time slot of the Side Third packet may be filled with the actual diagnosis data.

In an embodiment, the leading time slot or leading sub-frame of the Side First packet and the trailing time slot or trailing sub-frame of the Side Third packet are filled with a diagnosis data start symbol and a diagnosis data end symbol, respectively. However, the leading time slot or leading sub-frame of the Side First packet and the trailing time slot or trailing sub-frame of the Side Third packet may be assigned as a modifiable data area between communication hosts.

For example, the time-division multiplexed time slots or sub-frames may be assigned as 8 bits. The data frame (see FIGS. 11 and 12) may be assigned a total of 64 bits, composed of 8 unit time slots or sub-frames, with each unit being assigned 8 bits.

In an embodiment, to generate the data frame of a side channel that includes both video auxiliary data and diagnosis data (see FIGS. 11 and 12), the FPGA block (see FIGS. 8 and 9) may include: eight input channels connected to input registers where special codes, video auxiliary data, and diagnosis data (or stuffing symbols) are stored; and a multiplexer (MUX) to implement multiplexing for the eight input channels. For example, the multiplexer may form a sequence of 8-bit parallel data, where special codes, video auxiliary data, and diagnosis data (or stuffing symbols) are transmitted through their respective assigned time slots or sub-frames. This sequence of multiplexed (or mixed) 8-bit parallel data may then be line-encoded and/or block-encoded (see the encoder in FIG. 9). For example, an encoder may perform appropriate line encoding to ensure that the positive and negative voltages are balanced (DC balance), preventing signal distortion from DC components in the multiplexed parallel data. This encoding also considers synchronization between the display source and the display sink. In addition, the encoder (see FIG. 9) may perform 8b/10b encoding on the multiplexed (or mixed) parallel data, which includes special codes, video auxiliary data, and diagnosis data (or stuffing symbols), by, for example, converting an 8- bit input to a 10-bit output. This block encoding ensures a DC balance between positive and negative voltages and enables the detection of data transmission errors (bit errors).

In an embodiment, the FPGA block (see FIG. 3) may include FPGA control logic (programmable fabric), which is an array of programmable logic blocks for performing processing according to a preset process or logic, and a memory (RAM), which works in conjunction with the FPGA control logic for data operations such as reading, writing, and updating (e.g., CRUD). In addition, the FPGA block may include a multiplexer for multiplexing the processed diagnosis data and video auxiliary data, an encoder for line encoding and/or block encoding, and a SerDes. The SerDes is responsible for converting parallel data (a sequence of parallel data forming a multiplexed data frame of diagnosis data (or stuffing symbols) and video auxiliary data) into serial data, and converting serial data (a sequence of serial data forming a multiplexed data frame of diagnosis data (or stuffing symbols) and video auxiliary data) transmitted from the opposite display source, display sink, or FPGA block via an optical link, into parallel data (a sequence of parallel data forming a multiplexed data frame of diagnosis data (or stuffing symbols) and video auxiliary data, see FIGS. 11 and 12) suitable for the FPGA block's processing.

In an embodiment, more specifically, the FPGA block (see FIGS. 8 and 9) may include a multiplexer that implements multiplexing among: input channels (first to eighth input channels) connected to input registers where a special code is stored from the FPGA control logic; input channels (first to eighth input channels) connected to input registers that receive processed video auxiliary data from the FPGA control logic; and input channels (first to eighth input channels) connected to input registers that receive diagnosis data output from the FPGA control logic as another data processing flow. It may also include an encoder that takes as input the sequence of 8-bit parallel data (a sequence of parallel data forming a multiplexed data frame of diagnosis data (or a stuffing symbol) and video auxiliary data) output from the multiplexer and encodes it. Finally, it may include a SerDes (shift register) that outputs the sequence of parallel data received according to a parallel clock as a sequence of serial data (a sequence of serial data forming a multiplexed data frame of diagnosis data (or a stuffing symbol) and video auxiliary data) according to a serial clock. In an embodiment, the FPGA block (see FIG. 3, either the first or second FPGA block) may process video auxiliary data and diagnosis data according to a preset process or logic. This logic defines operations such as CRUD (create, read, update, delete) for data received from a display source or a display sink, as well as for data transmitted from the second FPGA block on the display sink side or the first FPGA block on the display source side. For example, the video auxiliary data and diagnosis data transmitted from a display source or display sink, or from the second FPGA block on the display sink side or the first FPGA block on the display source side, may be converted into a sequence of serial data (a sequence of serial data forming a multiplexed data frame of diagnosis data (or a stuffing symbol) and video auxiliary data) through processing from the input registers connected to the FPGA control logic up to the SerDes (shift register). This serial data may then be transmitted to the opposite side of the optical link. In an embodiment, the FPGA block (see FIG. 3, the first or second FPGA block), along with processing video auxiliary data and diagnosis data transmitted from a display source or sink, may generate diagnosis data regarding the optical link's status (such as operating temperature, operating voltage, and the link's own identification information) by taking as input raw data (e.g., video auxiliary data like HPD (hot plug detection) or other data) transmitted from the display source or sink. As described above, the sequence of parallel data (a sequence of parallel data forming a multiplexed data frame of diagnosis data (or a stuffing symbol) and video auxiliary data) containing the video auxiliary data and diagnosis data may be converted into a sequence of serial data (a sequence of serial data forming a multiplexed data frame of diagnosis data (or a stuffing symbol) and video auxiliary data). This conversion is done via an encoder, which performs line and/or block encoding, and a SerDes (shift register), which converts the data into a serial format for transmission over the optical link. The parallel data sequence is output from a multiplexer (MUX), which implements multiplexing between the input channels (first to eighth input channels) where the diagnosis data (output from the FPGA control logic to an input register) and video auxiliary data are received. The resulting serial data sequence may then be transmitted to the opposite end of the optical link. For example, the multiplexer (MUX) (see FIGS. 8 and 9) may implement multiplexing among the first to eighth input registers, or the first to eighth channels connected to them, that output special codes, video auxiliary data, and diagnosis data according to a parallel clock. The MUX may output a sequence of parallel data containing special codes, video auxiliary data, and diagnosis data by multiplexing the first to eighth channels according to the switching of a control signal that is synchronized with the time slots or sub-frames for Time Division Multiplexing (TDM). In addition, the SerDes (shift register, see FIGS. 8 and 9) takes as input the sequence of parallel data, which includes special codes, video auxiliary data, and diagnosis data, that is output from the multiplexer (MUX). It may then sequentially output a sequence of serial data containing special codes, video auxiliary data, and diagnosis data, according to a serial clock.

In an embodiment, the input register (see FIG. 9), multiplexer, encoder, and SerDes (shift register, serializer and deserializer, parallel to serial, serial to parallel) may be synchronized by using a parallel clock. For example, the multiplexer (MUX) may output parallel data, including a special code, video auxiliary data, and diagnosis data, that is assigned to a time slot or sub-frame synchronized with the parallel clock. Accordingly, the SerDes (shift register) may receive the parallel data according to the parallel clock (which is synchronized with the input register, multiplexer, and encoder) and output serial data (special code, video auxiliary data, and diagnosis data) according to a serial clock.

In an embodiment, the data contained in the side channel, which includes video auxiliary data and diagnosis data, or a data frame with a structure as described above (see FIGS. 11 and 12), may include 8-unit (each unit: 8 bits, 1 byte) time slots or sub-frames for time-division multiplexing. For example, in an embodiment, a data frame for a non-diagnosis instance (see FIG. 11), which includes only video auxiliary data and no diagnosis data, may have a structure with alternately assigned special code areas (K-CODE) and data areas (D-CODE). The data area (D-CODE) assigned for diagnosis data may be filled with a stuffing symbol (0x00). In contrast, a data frame for a diagnosis instance (see FIG. 12), which includes both video auxiliary data and diagnosis data, may have a structure where, except for the special code area (K28.7) representing the start of the data frame, all other areas may be assigned as a data area (D-CODE). The data area (D-CODE) between the diagnosis data start symbol (0xDE) and the diagnosis data end symbol (0xED) may be filled with the diagnosis data. In an embodiment, each special code area (K-CODE) and data area (D-CODE) that forms the data frame may be assigned 1 byte (8 bits). The data capacity of the time slots or sub-frames for Time Division Multiplexing (TDM) of the data frame (see FIGS. 8 and 9), which includes the special code areas and data areas, may be determined based on the data frame's total capacity (8 bytes, 64 bits) and the optical link's transmission speed (e.g., 16 MBps-megabytes per second).

In an embodiment, an optical link for providing a diagnosis and monitoring function may be connected between a display source and a display sink, forming a system that supports HDMI (see FIG. 2) or DisplayPort (DP) (see FIG. 1). This link may transmit video data containing video information, and video auxiliary data, which includes: rendering configuration data such as Extended Display Identification Data (EDID), related to the display sink's rendering; and channel configuration data such as DisplayPort Configuration Data (DPCD), related to the channel setup of the main channel (or main lane) that transmits the video data and rendering configuration data.

More specifically, video auxiliary data may be transmitted not through the main channel (or main lane) for high-speed video data transmission in HDMI (see FIG. 2) and DisplayPort (DP, see FIG. 1), but through a side channel (HDMI's DDC channel or DP's auxiliary (AUX) channel). In HDMI, this may include video auxiliary signals such as SCL (DDC channel clock line), SDA (DDC channel data line), 5V power supply (DDC_5V), Hot Plug Detection (HPD), and Customer Electronic Control (CEC). In DisplayPort, it may include video auxiliary signals such as HPD and DPCD.

In an embodiment, an optical link that implements a diagnosis and monitoring function allows for the monitoring of diagnosis data through a graphical interface screen rendered by a Graphic User Interface (GUI) program on an administrator interface. This administrator interface is connected to the USB port of either an optical transmitter (see FIG. 4A) on the display source side or an optical receiver (see FIG. 4B) on the display sink side. This diagnosis and monitoring function enables the user to check the output status of the screen rendered on the display sink side. When the screen is not being displayed or the output quality is poor, the diagnosis and monitoring function provided by the optical link may help reduce maintenance costs, such as those for reconnection or repair.

In an embodiment, the diagnosis data subject to the optical link's diagnosis and monitoring function may include: the connection status between the display source and the display sink (e.g., the connection status between the display source and the optical link mediating video data transmission, and the connection status with the display sink); the presence or absence of an output signal from the display source side; the presence or absence of an output signal from the display sink side; the presence or absence of a signal on a per-channel basis on the display sink side (e.g., HDMI's Channel 0, Channel 1, Channel 2, Clock Channel; DisplayPort's Lane 0, Lane 1, Lane 2, Lane 3, see FIGS. 1 and 2); the communication status between the display source and the display sink (e.g., the communication status of the two-way side channel); the operational status of the optical link (e.g., operating temperature, operating voltage); and the identification information of the optical link itself (e.g., the identification information of the USB device, the optical link, recognized from the combination of Vendor ID (VID) and Product ID (PID) by the administrator interface, the host side, to which the optical link is connected as the device side via a USB communication channel). In an embodiment, an optical link with a USB communication channel established with an administrator interface may be determined to be a preset or predefined USB device to decide whether it is a target for diagnosis and monitoring.

In various embodiments, it is necessary to match the Application Programming Interface (API) format, such as the communication data format or structure, between the GUI program on the administrator interface and the USB-connected optical link. In addition, for diagnosis and monitoring to be provided from the administrator interface, the USB-connected device needs to be restricted to an optical link. Therefore, the administrator interface must verify whether the product with the established USB communication channel is an optical link. when the administrator interface determines, based on the combination of VID and PID read from the USB device's configuration, that the recognized USB device falls outside a preset or predefined category, it may cease further diagnosis and monitoring and display an error message on the graphical interface screen.

In an embodiment, the video quality rendered on the display sink side may be optimized by modifying or fixing the video auxiliary data. This data includes rendering configuration data such as EDID (Extended Display Identification Data), which is related to the display sink's rendering, and channel configuration data such as DPCD (DisplayPort Configuration Data), which is related to the channel setup of the main channel (or main lane) that transmits video data. This optimization is performed between the optical link and the administrator interface.

An optical link that provides a sensing and monitoring function according to an embodiment may be connected to the optical link's USB port (the USB port of the optical transmitter or optical receiver) either directly by a computing terminal that forms a administrator interface or via a system (hereinafter referred to as a diagnosis and monitoring system) that implements the optical link's diagnosis and monitoring as described below.

Hereinafter, a system for implementing the diagnosis and monitoring of an optical link will be described in more detail. This system provides a data processing and data transmission channel between the optical link and an administrator interface, according to an embodiment.

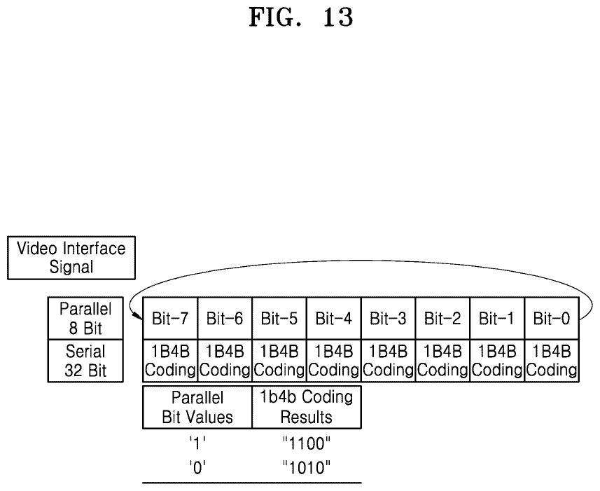

FIG. 14 shows a diagram for describing an overall structure of a system for implementing diagnosis and monitoring of an optical link, according to an embodiment.

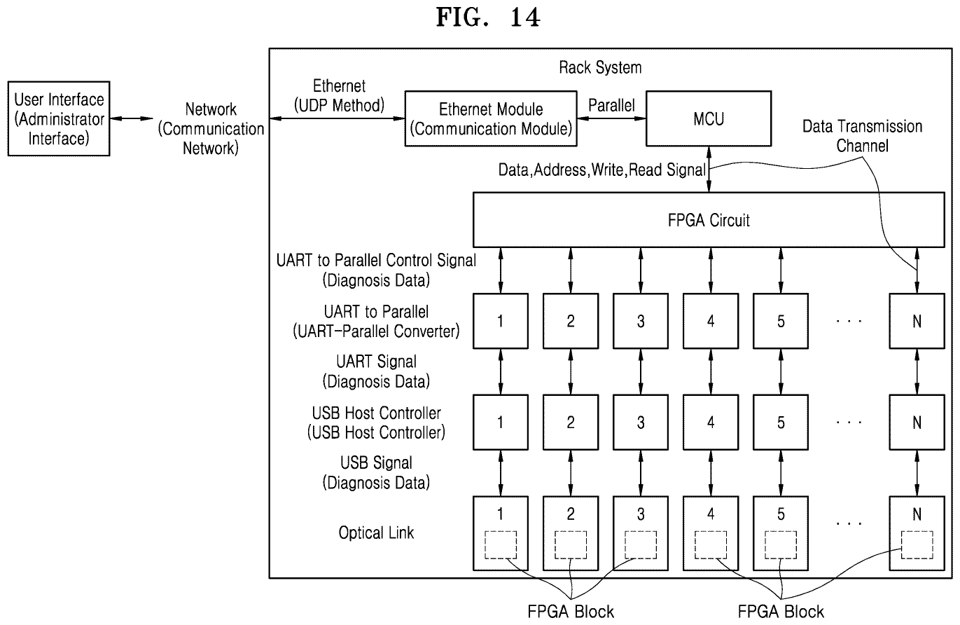

FIG. 15 is a diagram for describing a USB host controller shown in FIG. 14.

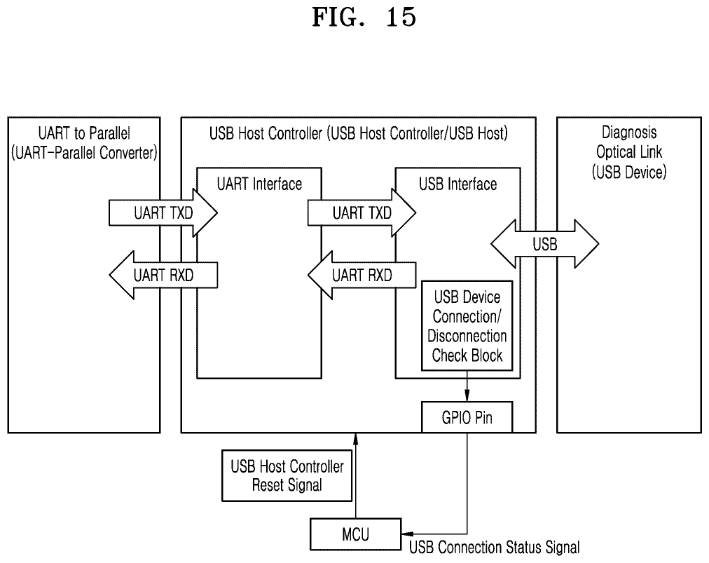

FIG. 16 is a diagram for describing multiplexing of a plurality of data transmission channels respectively connected to optical links between the FPGA circuit and the MCU shown in FIG. 4 from TDM through a single connection channel between the FPGA circuit and the MCU.

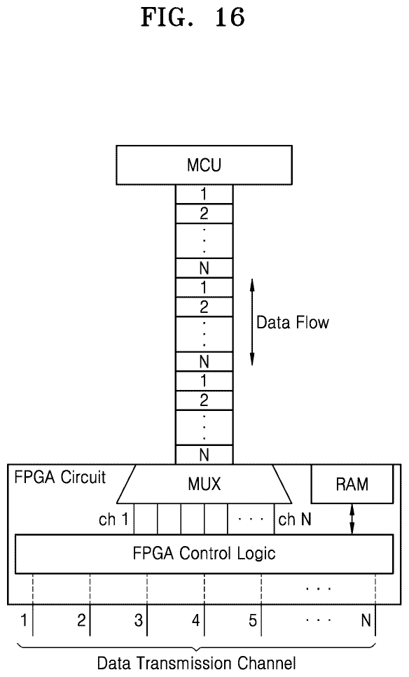

FIG. 17 shows a diagram for describing a data structure of universal achromous receiver/transmitter (UART) communication data that is converted from a USB interface of a USB host controller, which receives USB communication data, and transmitted toward a UART-parallel converter, wherein the UART communication data structure includes Start bit, Data bit, Parity bit, Stop bit, and IDLE period.

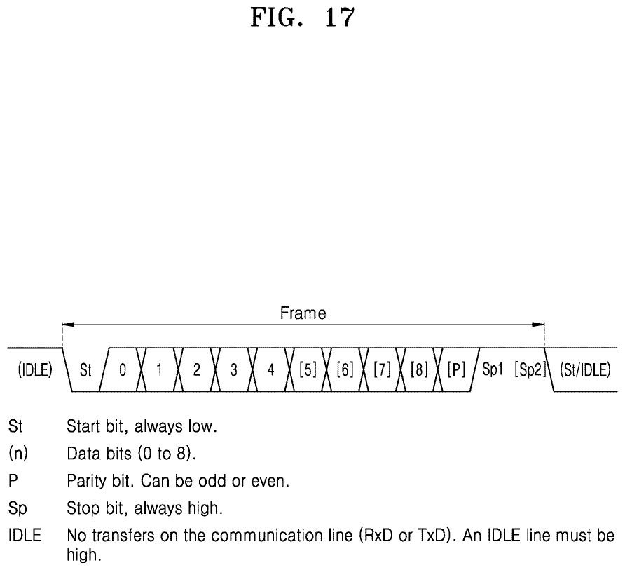

FIG. 18 is a diagram for describing a USB connection between the USB host controller and the optical link shown in FIG. 14, wherein, a USB connection with the USB host controller as a host (Down Facing Port (DFP)) and the optical link as a device (Up Facing Port (UFP)), a CC logic and Vconn switch for controlling a MUX for allowing un-flipped or flipped connection corresponding to plug orientation depending on the connection status between them and switching between input and output channels of the MUX, and for power supply of an Electronically Marked IC (EMIC).

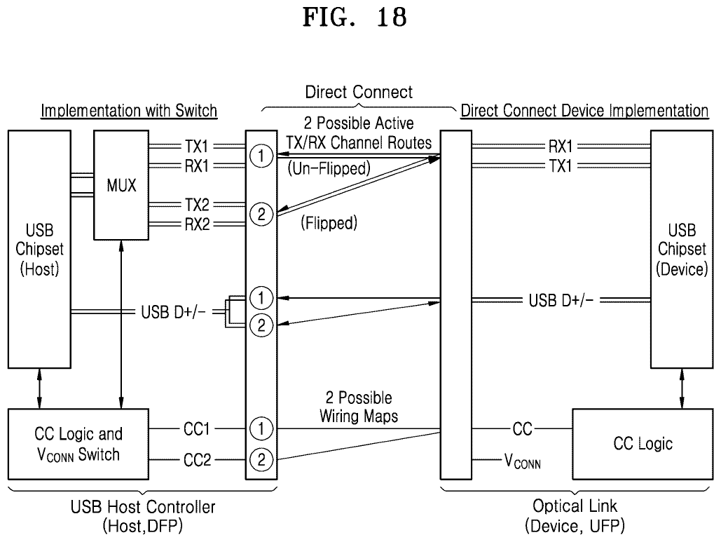

FIG. 19 is a diagram for describing a pin configuration and configuration control of a USB port (USB C-type) in a USB connection between the USB host controller and the optical link shown in FIG. 14, wherein Configuration Channels (CC) (CC1 and CC2) detects USB connection/separation and involves in role determination and plug orientation (un-filled or flipped) between USB communication hosts and power delivery (PD) communication (or baseband communication).

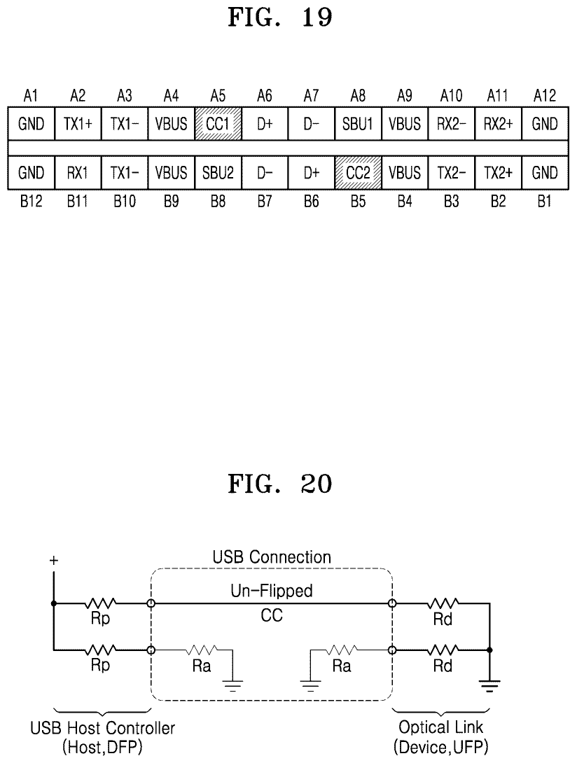

FIG. 20 is a diagram for describing a USB communication between the USB host controller and the optical link shown in FIG. 14, wherein, in a USB communication with the USB host controller as a host and the optical link as a device, the USB connection and plug orientation (un-filled or flipped) are detected, and for role determination, shown are a pull-up resistor (Rp) connected to CC of the USB host controller forming the host, a pull-down resistor (Rd) connected to CC of the optical link forming the device, and a resistor (Ra) capable of detecting active cable circuitry such as EMIC.

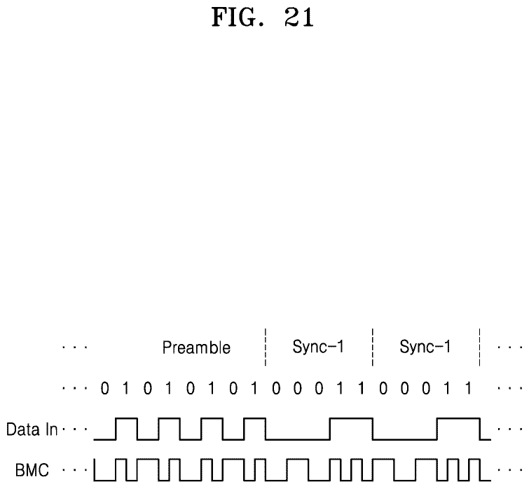

FIG. 21 is a diagram for describing a USB communication between the USB host controller and the optical link shown in FIG. 14, a PD communication (or baseband communication) related to power supply and role determination between CC of the USB host controller and CC of the optical link, and PD communication encoded by biphase mark coding (BMC).

In an embodiment, a system for implementing the diagnosis and monitoring of an optical link (hereinafter referred to as the “diagnosis and monitoring system,” see FIG. 14) provides a data processing and data transmission channel between the optical link and an administrator interface. This system may transmit diagnosis data to the administrator interface to provide diagnosis and monitoring of the optical link's connection status. This diagnosis data includes overall status information of the optical link that may affect the output of video quality rendered on the display sink side in systems supporting HDMI (see FIG. 2) or DisplayPort (DP, see FIG. 1). The data specifically includes the connection status between the display source or sink and the optical link, the operational status of the optical link, and the identification information of the optical link itself. The optical link, which is a diagnosis target of the diagnosis and monitoring system (see FIG. 14), may transmit video data containing video information, along with video auxiliary data. This video auxiliary data includes: channel configuration data, such as DPCD (DisplayPort Configuration Data), related to the setup of the main channel (or main lane) for transmitting video data; and rendering configuration data, such as EDID (Extended Display Identification Data), related to the display sink's rendering.

In an embodiment, a diagnosis and monitoring system (see FIG. 14) providing a data processing and data transmission channel between an optical link and an administrator interface may be connected to the USB port of the optical link's FPGA block (see FIG. 3) or an optical communication module that includes the FPGA block (see FIGS. 4a and 4b) to monitor the optical link's status information. This may form a USB connection where the diagnosis and monitoring system acts as the host and the FPGA block acts as the device. The diagnosis and monitoring system may transmit requests for diagnosis data to the FPGA block with which a USB communication channel is established. It may then receive the requested diagnosis data and even request updates, modifications, or changes to the data. In an embodiment, the diagnosis and monitoring system (see FIG. 14) may form a one-to-many parallel USB connection with a plurality of optical links (e.g., with the FPGA block of each of the a plurality of optical links, see FIG. 3) to provide diagnosis and monitoring for them.

In an embodiment, the diagnosis and monitoring system (see FIG. 14) may be connected to at least one of the first or second FPGA blocks (see FIGS. 1 and 2), which are adjacently connected to either the display source or the display sink. For example, by connecting to the first FPGA block, which is adjacent to the display source, the system may obtain diagnosis data primarily related to the display source, such as the connection status between the display source and the optical link, or the presence of an output signal from the display source. Conversely, by connecting to the second FPGA block, which is adjacent to the display sink, the system may obtain diagnosis data primarily related to the display sink, such as the connection status between the display sink and the optical link, or the presence of an input signal at the display sink. The first FPGA block and the second FPGA block are connected to each other via an optical link and may perform data communication, which includes requesting and receiving diagnosis data about the connection status between each of the FPGA blocks and their adjacent display source or sink. Consequently, by connecting to just one of the first or second FPGA blocks, you may obtain all diagnosis data regarding the connection status between the display source and the optical link, as well as the connection status between the display sink and the optical link.

In an embodiment, a diagnosis and monitoring system (see FIG. 14) provides a data processing and data transmission channel between an optical link and an administrator interface. To enable the simultaneous diagnosis and monitoring of the connection status, operational status, and identification information of a plurality of optical links, the system may form a one-to-many connection with them (e.g., with the FPGA block of each optical link, see FIG. 3, or the optical communication module containing the FPGA block, see FIGS. 4a and 4b). This allows the diagnosis and monitoring system to acquire diagnosis data for each optical link, and a data transmission channel may be established with each link, forming a plurality of data transmission channels connected in parallel to the a plurality of optical links. In an embodiment, a data transmission channel on each of the a plurality of optical links (the FPGA block of each optical link) may include: a plurality of USB host controllers that each form a one-to-one USB communication channel with a respective optical link; a UART-parallel converter connected to the a plurality of USB host controllers, forming a one-to-one UART communication channel with them; a single FPGA block that forms a one-to-many parallel communication channel with the USB host controllers or the UART-parallel converters, connecting in parallel to form a one-to-many connection; a single MCU (Micro Controller Unit) that forms a parallel communication channel with the FPGA block; and a communication module (e.g., an Ethernet communication module) that forms a parallel communication channel with the MCU. The data transmission channel, formed within the diagnosis and monitoring system (see FIG. 14) via these a plurality of components, may then connect to the administrator interface through a communication network from the communication module.

In an embodiment, the diagnosis and monitoring system (see FIG. 14) may form a one-to-many USB connection. In this setup, a single USB host controller acts as the common host for a plurality of USB connections, with the a plurality of optical links (connected to a USB hub that supports a plurality of USB connections) serving as the devices. Alternatively, it may form one-to-one USB connections, where a plurality of USB host controllers each act as the host for a respective USB connection, with each optical link serving as a device. The diagnosis and monitoring system (see FIG. 14) may include a plurality of USB host controllers, with the a plurality of optical links serving as the USB devices. Accordingly, each USB connection may form a one-to-one USB connection, with one optical link (the FPGA block of the optical link, see FIG. 3, or an optical communication module containing the FPGA block, see FIGS. 4a and 4b) acting as the device, and a respective assigned USB host controller from within the diagnosis and monitoring system (see FIG. 14) acting as the host. In contrast to an embodiment of the present invention, when the diagnosis and monitoring system includes only a single USB host controller and forms a one-to-many USB connection (with the single controller as the host and a plurality of optical links connected via a USB hub as devices), the single USB host controller must perform a separate process for each of the a plurality of optical links (their FPGA blocks) to set up the USB communication channel. For example, this process may include: verifying the connection of each USB port on the hub; setting roles (e.g., DFP, UFP, or DRP) or data transfer speeds (LS, HS, FS) by detecting pull-up (Rp, see FIG. 20) or pull-down (Rd, see FIG. 20) resistors; and performing baseband communication for power delivery settings. Such a system, with a single USB host controller acting as the communication host for a plurality of USB ports (e.g., on a USB hub), may experience time delays in setting up the a plurality of USB communication channels. Furthermore, when a USB connection is released, there may be a time delay for recovering and initializing assigned computational resources, such as setting the initial levels by connecting to the pull-up (Rp, see FIG. 20) or pull-down (Rd, see FIG. 20) resistors of the Configuration Channel (CC, see FIG. 19). Even with established USB communication channels, traffic for communication with a plurality of optical links (the FPGA block of the optical link, or an optical communication module including the FPGA block, see FIGS. 3, 4a, and 4b) is concentrated on the single USB host controller, which may cause time delays in processing diagnosis data, such as requesting, receiving, or storing data for the a plurality of optical links. Due to the limited processing capacity of the single USB host controller, time delays in computational processing-like requesting diagnosis data or processing received data for each optical link-can occur during USB connection/disconnection events (e.g., when a new optical link is connected or an existing one is disconnected). Considering this, a diagnosis and monitoring system (see FIG. 14) applicable to an embodiment may provide a USB host controller for each optical link, creating a one-to-one connection between the optical link and the USB host controller. This allows the system to simultaneously perform diagnosis and monitoring of the status information of a plurality of optical links-including their connection status, operational status, and identification information-without causing time delays in the transmission, reception, or processing of diagnosis data related to setting up or releasing the USB communication channel for each link. For example, by having a dedicated USB host controller handle the USB communication channel traffic for each of the a plurality of optical links (e.g., the FPGA block of the optical link, see FIG. 3, or an optical communication module containing the FPGA block, see FIGS. 4a and 4b), time delays in processing diagnosis data regarding the connection status of the a plurality of optical links may be avoided.

In an embodiment, a plurality of data transmission channels, which are formed in parallel within the diagnosis and monitoring system (see FIG. 14) to establish a data or control signal flow for processing diagnosis data for each optical link, may be connected in parallel to a single FPGA circuit within the diagnosis and monitoring system. This is achieved through a dedicated USB host controller for each optical link, which functions as the communication host for the USB connection. The flow of diagnosis data or control signals for processing the data may then be processed in parallel at the FPGA circuit. For example, the FPGA circuit (see FIG. 16) may include FPGA control logic (a programmable fabric) to perform processing according to preset processes or logic, and a memory (RAM) that works in conjunction with the FPGA control logic for data operations such as reading, writing, and updating (e.g., CRUD). This makes it advantageous for parallel tasks compared to an MCU connected to it along the data transmission channel. For instance, the FPGA circuit may perform parallel operations, such as the input and output of diagnosis data or control flows for processing the data, through a plurality of data transmission channels. These a plurality of data transmission channels, which are formed in parallel within the diagnosis and monitoring system to create individual connection channels with a plurality of optical links, may be connected in parallel to the FPGA circuit, and a single connection channel may be formed between the FPGA circuit and the MCU (see FIG. 16). In other words, the data transmission channels for the input and output data of the a plurality of optical links may be formed as individual connection channels between the a plurality of host controllers and the FPGA circuit. However, they may be formed as a single connection channel between the FPGA circuit and the MCU.

As will be described later, unlike the FPGA circuit (see FIG. 16), the MCU may support serial processing and time-division-based multiprocessing. For example, the flow of diagnosis data or control signals for processing the data from a plurality of optical links connected to the diagnosis and monitoring system may be processed in a parallel manner by the FPGA circuit, whereas the flow of diagnosis data or control signals for processing the data with the FPGA circuit may be handled by the serial-processing MCU as time-division-based multiprocessing. In an embodiment, the data transmission channel formed within the diagnosis and monitoring system (see FIG. 14) may be structured as parallel connection channels from the USB connections with the a plurality of optical links up to the parallel-processing FPGA circuit. It may then transition to a single connection channel from the FPGA circuit to the serial-processing MCU.

The FPGA circuit (see FIG. 16) may include FPGA control logic (a programmable fabric), which is an array of programmable logic blocks that perform processing based on preset processes or logic. It may also include a memory (RAM) that works with the FPGA control logic for operations such as reading, writing, and updating data. In addition, the FPGA circuit (see FIG. 16) may include a multiplexer (MUX) for multiplexing data (e.g., via Time Division Multiplexing, TDM) from or to a plurality of data transmission channels that are connected in parallel to the FPGA circuit. In an embodiment, the FPGA circuit may include a multiplexer (MUX) to implement time-division multiplexing (TDM). This allows it to transmit data from a plurality of data transmission channels, which are connected in parallel to the FPGA circuit, through a single connection channel between the FPGA circuit and the MCU. Consequently, the diagnosis and monitoring of a plurality of optical links connected to the diagnosis and monitoring system may be implemented as time-division multiprocessing for each optical link. This may be executed by the MCU's time-division multiprocessing to control the overall operation of the diagnosis and monitoring system. For example, the MCU may generate and transmit control signals (commands) to control the overall operation of the system based on a request from the administrator interface. In response, it may receive diagnosis data from the corresponding optical link and transmit it back to the administrator interface. In this way, the MCU may form a data input/output flow, including the transmission of control signals for data requests and the reception of requested data, through the data transmission channel. It may also process tasks related to each optical link via time-division multiprocessing through the multiplexer (MUX) of the FPGA circuit (see FIG. 16), to which a plurality of data transmission channels are connected in parallel. For example, in an embodiment, the multiplexer (MUX) of the FPGA circuit may multiplex data that is input or output through the connection channels of first to N^{th} optical links via time-division multiplexed time slots. Based on a control signal (synchronized with a clock), the system may sequentially process tasks related to each of the first to N^{th} optical links by sequentially inputting and outputting data through their respective connection channels, which demonstrates the MCU's time-division multiprocessing.

In an embodiment, the multiplexing of data from or to the connection channels of the first to N^{th} optical links (see FIG. 16) may implement Asynchronous Time Division Multiplexing (ATDM) (see FIG. 10B). For example, when some of the first to N^{th} optical links are disconnected, the time slots assigned to the disconnected links may be assigned to other optical links. This approach may not correspond to Synchronous Time Division Multiplexing (STDM) (see FIG. 10A), in which, even when a link (e.g., the second optical link) is disconnected, the time slot assigned to its connection channel is left empty or filled with a stuffing symbol instead of being filled with data from other optical links. In an embodiment, by using Asynchronous Time Division Multiplexing (ATDM, see FIG. 10B), the MCU, which controls the overall operation of the diagnosis and monitoring system and sequentially performs tasks for the first to Nth optical links, may detect when the second optical link, for example, transitions from a connected to a disconnected status. It may then reassign the time slot assigned to the data being input or output through the second optical link's connection channel to another optical link. The MCU, which was performing tasks sequentially for the first to N^{th} optical links, may then skip the task related to the disconnected second optical link and proceed directly from the task for the first optical link to the task for the third optical link. As will be described below, the USB host controller (see FIG. 15), which acts as the host for the USB communication channel with each optical link (the FPGA block of the optical link or an optical communication module containing the FPGA block), may switch the output of its GPIO pin to a high/low signal based on the connection/disconnection status of the optical link. The MCU, upon detecting this switch in the output level of the USB host controller's GPIO pin, may initiate a reset operation for that USB host controller. Simultaneously, it may control the FPGA circuit (see FIG. 16, e.g., the FPGA circuit's multiplexer) to avoid assigning a time slot for time-division multiplexing to the data transmission channel connected to the USB host controller with the detected output level switch. Instead, it may assign the time slot to another data transmission channel, thereby implementing Asynchronous Time Division Multiplexing (ATDM) (see FIG. 16). Consequently, the MCU may skip tasks related to the disconnected optical link and immediately move on to the next one in the sequence. This prevents the waste of computational time for the disconnected optical link in the time-division multiprocessing, allowing for the faster processing of tasks related to other optical links that remain connected.

In an embodiment, a description of each component connected to the data transmission channel within the diagnosis and monitoring system (see FIG. 14) is as follows. The MCU may include an arithmetic and logic unit (ALU) for arithmetic and logic operations, as well as a cache or register for the temporary storage of variables that are input to and output from the ALU. Unlike an FPGA block (FPGA control logic), which processes preset processes or logic either independently or in parallel, the MCU supports serial processing and may provide time-division-based multiprocessing, similar to a multi-thread system. For example, the MCU is well-suited for sequential or serial tasks and, consisting of a relatively small number of cores, may quickly process a small volume of complex calculations. In contrast, the FPGA block (FPGA control logic) is advantageous for parallel tasks and may quickly process a large volume of relatively simple calculations. For example, in an embodiment, the MCU may function as a central processing unit or central control unit capable of controlling the overall operation of the diagnosis and monitoring system. The MCU may follow control commands received from an administrator terminal via a communication module and transmit a control command (control signal) containing data such as Data, Address, Write, and Read to the FPGA block. For instance, it may output a control command to the FPGA circuit that includes the target address (device address) of the intended optical link, the designated Write/Read mode, and the Data. It may also transmit control commands to the MCU itself through a parallel communication channel.

The FPGA circuit (see FIG. 16), according to a process or logic set within its FPGA control logic that is called by a control command from the MCU, may perform CRUD (create, read, update, delete) operations on diagnosis data for a specific optical link. This targeted link is chosen from among the a plurality of optical links connected to the diagnosis and monitoring system (see FIG. 14) and is specified by an address in the control command (e.g., a target address or device address). The FPGA may request or receive requested diagnosis data, or request changes or modifications to the data, which includes the optical link's connection status, operational status, and identification information.

The FPGA circuit (see FIG. 14) may transmit a control signal that follows a command from the MCU to a UART-parallel converter via a parallel communication channel. This UART-parallel converter may convert parallel data into serial UART communication data. For example, the UART-parallel converter may form an asynchronous serial communication UART channel that does not require a separate clock signal, allowing data to be read from the transmission speed (baud rate) and the start bit (e.g., bit 0) and stop bit (e.g., bit 1) defined by the communication protocol.

The USB host controller (see FIG. 15) may function as the host in USB connections formed with a plurality of optical links, where each optical link (the FPGA block of the optical link or an optical communication module including the FPGA block) serves as the device. Through the USB host controller, UART communication data transmitted from the UART-parallel converter may be converted into USB communication data and sent to the connected optical link. Conversely, USB communication data from the USB-connected optical link may be converted into UART communication data and sent to the UART-parallel converter.

More specifically, the USB host controller (see FIG. 15) may include a UART interface (see FIG. 15) and a USB interface (see FIG. 15). The UART interface re-adjusts the data structure, control information, and timing to conform to the UART communication protocol. This includes re-adjusting the data structure (format, coding, signal level, sequence), control information (interpretation of signal patterns, transmission control, error correction), and timing (speed adjustment, message transmission time, transmission order) to align with the UART communication protocol. Conversely, the USB interface re-adjusts the data structure, control information, and timing to conform to the USB communication protocol. The USB host controller may perform a process to re-adjust the data structure, control information, and timing between these two different communication protocols.

For example, the USB host controller (see FIG. 15) may provide an execution environment within the same process to create and execute two different threads, each containing a main function. Within the process that provides the execution environment for these two threads, they may share the memory's code area, data area, and heap area, while the stack area may be assigned individually for each thread.

For example, the two different threads may include a thread for converting UART communication data (which follows the UART communication protocol) into USB communication data (which follows the USB communication protocol), which is the UART interface (see FIG. 15), and a thread for the reverse conversion, from USB communication data to UART communication data, which is the USB interface (see FIG. 15). For example, these different threads (UART interface and USB interface, see FIG. 15) may be executed independently. Each thread for USB-UART conversion may convert incoming UART or USB communication data into the other format in defined units where error detection or error correction is possible. This unit may be, for instance, a data frame unit or an entire series of continuous signals that are continuously transmitted from one communication host to the other. when the conversion occurs in the middle of such a unit, the data may be converted into a signal containing errors and then transmitted to the next stage before error detection or correction may take place. Therefore, the UART-USB conversion may be performed at least in units where error detection and correction are defined, such as a complete data frame or an entire series of continuous signals.

The thread for converting UART communication data to USB communication data (the UART interface, see FIG. 15), on the data transmission channel heading from the MCU or FPGA circuit (see FIG. 14) toward the USB-connected optical link, and the thread for the reverse conversion (the USB interface, see FIG. 15), which takes USB communication data as input on the data transmission channel heading from the USB-connected optical link toward the MCU or FPGA circuit, may be executed independently. These two different threads (the UART interface and the USB interface) may share the code area (where functions are stored), the data area (where global variables are stored), and the heap area (for dynamic memory allocation) within the same process that provides the execution environment. However, the stack area (where local variables and function parameters are stored) may be assigned individually for each thread (see FIGS. 6 and 7). As described above, the different threads (UART interface and USB interface, see FIG. 15) may be executed independently. However, a global variable related to the optical link's connection/disconnection status may be stored in a shared data area, allowing information about the status to be shared between the different threads. This connection/disconnection status information may be detected from the output level of the GPIO pin of the USB host controller (see FIG. 15), which acts as the communication host for the USB connection with the optical link. The USB host controller may switch the output level of its GPIO pin to a high or low signal based on the connection/disconnection status of each optical link. This change in the USB host controller's GPIO pin output level may be detected by the MCU, which may then initiate a reset operation for the USB host controller under its control. This may then cause the global variable related to the optical link's connection/disconnection, which is shared between the threads (the UART interface and USB interface) running on the USB host controller, to be changed.

In an embodiment, by allowing the different threads (the UART interface and the USB interface) running on the USB host controller (see FIG. 15) to execute independently, it is possible to fundamentally prevent errors caused by conflicts between these threads, such as conflicts in their functions, libraries, or variables. For example, the respective threads for UART-USB conversion (UART interface and USB interface, see FIG. 15) may be executed independently. Each thread for UART-USB conversion may convert incoming UART or USB communication data into the other format in units where error detection or error correction is defined, or as an entire series of continuous data transmitted from one communication host to another (i.e., the entire unit received up to the last byte). when the UART-USB conversion occurs in the middle of such a unit, the data may be converted with an error before error detection or correction, and then transmitted to the next stage (the optical link or the UART-parallel converter). Therefore, the UART-USB conversion may be performed on a complete unit that allows for error detection or correction (e.g., a data frame unit) or on the entire series of continuous data transmitted from one communication host to another (the entire unit received up to the last byte). For instance, in an embodiment, the cross-conversion operation is not performed on a per-data frame basis but is instead performed only after the entire continuous data unit up to the last byte has been received. This occurs in a series of continuous data transmitted from one communication host (the UART-parallel converter and USB host controller, or the optical link and USB host controller) to the other.

The USB host controller (see FIG. 15) may manage a USB connection where the controller itself is the host, and the optical link (the FPGA block of each optical link or an optical communication module containing the FPGA block) is the device. For example, the USB host controller may detect the optical link's USB connection and output its connection/disconnection status through a separate GPIO (general purpose IO) pin. In an embodiment, the USB host controller (see FIG. 15) may output a high signal on its GPIO pin when the optical link is in a USB connected state, and a low signal when the optical link is in a USB disconnected state. The USB host controller (see FIG. 15) switches its GPIO pin's output to a high or low signal based on the change in the USB connection/disconnection status. An MCU that detects this change in the GPIO pin's output may initiate a reset operation for the USB host controller. For example, in an embodiment, as the USB host controller's reset operation is initiated under the MCU's control, it may perform an initialization for the USB connection. This includes the USB host controller connecting its Configuration Channel (CC, CC1, CC2, see FIG. 19) to a pull-up resistor (Rp, see FIG. 20), allowing the USB host controller to be set as the Host (Down Facing Port (DFP)) based on the USB connection. The USB host controller's initialization may also include setting an output level thereof. For example, in various embodiments, the CC (Configuration Channel, CC1, CC2, see FIG. 19) of the USB host controller may perform baseband communication (e.g., peak-to-peak 1.1V) to set up a USB communication channel. It may also be connected to VCON to supply power to components like an Electronically Marked IC (EMIC). When the optical link is first connected, it may display an output level different from the state connected to a pull-up resistor (Rp, see FIG. 19), which is used for initial connection status sensing or role determination. Through the USB host controller's initialization, it may perform output level initialization to ensure that in subsequent USB connections, the USB host controller is set as the host (DFP) by connecting its CC to a pull-up resistor (Rp, see FIG. 20) for connection status sensing and role determination between the USB communication hosts.

In an embodiment, the reset operation of the USB host controller (see FIG. 15) may include setting the output level of the USB host controller's GPIO pin and creating different threads for UART-USB conversion. For example, it may create a thread for converting UART communication data to USB communication data (the UART interface) and a kernel object to manage this thread. Similarly, it may create a thread for converting USB communication data to UART communication data (the USB interface) and a kernel object to manage it. After being created, these threads (the UART interface and the USB interface) may be executed.

In an embodiment, the USB host controller (see FIG. 15) may detect the USB connection of an optical link and change the GPIO pin's output level to a high signal. The USB host controller may also check whether the detected USB device (the optical link) is a predefined optical link by sensing the USB connection (e.g., sensing the connection of the other party's device via the CC) and then performing device recognition (emulation) of the optical link's FPGA block. More specifically, the USB host controller performs device recognition to identify the connected USB device (the optical link). It checks the 16-bit Vendor ID (VID), which is an identification mark for the manufacturer, and the 16-bit Product ID (PID), which is an identification mark for the manufacturer's product. From the combination of the VID and PID, it may recognize the connected USB device and verify when it is a predefined optical link. In an embodiment, when the USB host controller (see FIG. 15) detects a USB device connection and determines that the device recognized from the VID and PID combination is a predefined or preset optical link, it may output a high signal on its GPIO pin to indicate a connected state. Conversely, when the USB host controller detects a USB device connection but determines that the device recognized from the VID and PID combination is not a predefined or preset optical link, it may output a low signal on its GPIO pin to indicate a disconnected state, despite the connection being sensed.

In various embodiments, for seamless communication with the diagnosis and monitoring system (see FIG. 14), the USB device must adhere to preset rules or a protocol. For instance, a USB device produced by the same manufacturer as the diagnosis and monitoring system needs to follow preset rules for its communication with the system, including the data structure (e.g., format, coding, signal level, and sequence), control information (e.g., interpreting signal patterns, transmission control, and error correction), and timing (e.g., speed adjustment, message transmission time, and transmission order). Furthermore, even when a USB device is produced by the same manufacturer as the diagnosis and monitoring system, the system must block connections with USB devices other than the optical link, given its purpose of providing diagnosis and monitoring for the optical link's connection status. In an embodiment, a diagnosis and monitoring system may sense a USB connection and, through device recognition (emulation) of the connected USB device, read the VID and PID identification marks. It then determines whether the USB device recognized from the combination of the read VID and PID corresponds to a predefined or preset USB device. Based on the result, it may output a high or low signal on the USB host controller's GPIO pin. An MCU that senses the output from the USB host controller's GPIO pin may then perform diagnosis and monitoring for the USB-connected optical link.

In an embodiment, depending on the USB type supported by the diagnosis and monitoring system, both data and power may be supplied via the USB connection. For example, power may be supplied along with data communication between the diagnosis and monitoring system and the optical link. The optical link (the optical link's FPGA block, see FIG. 3, or the optical communication module containing the FPGA block, see FIGS. 4A and 4B) may receive its operating power from the diagnosis and monitoring system, which is connected to a commercial power grid. In response to a request to shut off power (a power-off request) for a specific optical link (along with its target address or device address) received via an administrator interface connected through a communication network, the MCU may control the USB host controller to cut the optical link's operating power. At this time, the USB host controller (see FIG. 15) may switch its connection/disconnection status with the targeted optical link, which in turn causes the output level of the USB host controller's GPIO pin to switch to a high or low signal. The MCU, upon detecting this change in the GPIO pin's output level, may then initiate a reset operation for the USB host controller. In an embodiment, a USB host controller's reset operation may be initiated in response to two events: the disconnection of a USB-connected optical link and a power-off request received from an administrator interface via a communication network. Following the reset, the USB host controller may be initialized. After a reset caused by a disconnection, the USB communication channel with the optical link may be re-established when a USB connection is detected again. Similarly, after a reset caused by a power-off, the power supply may be resumed in response to a request (a power-on request) received from the administrator interface, which also allows the USB communication channel to be re-established. When the USB communication channel with the optical link is re-established, it means that the data flow on the data transmission channel from the optical link may be processed by the MCU, which has detected a change in the USB host controller's GPIO pin output level. The data flow from the optical link may also be multiplexed with other data transmission channels via the multiplexer (MUX) of the FPGA circuit (see FIG. 16) under the MCU's control, allowing the tasks related to that specific optical link to be processed. In various embodiments, the diagnosis and monitoring system (see FIG. 14) may perform a power-off operation on an optical link either by cutting off the power supply from the USB host controller in response to a request (control command) from the administrator interface received via a communication network, or by transmitting a control signal to the optical link along the data transmission channel. For example, an MCU that has transmitted a control signal to the USB host controller for an optical link power-off may initiate a reset operation for the USB host controller. Alternatively, as the power supply to the USB-connected optical link is cut off by the USB host controller, the connection from the optical link is no longer detected. The USB host controller (see FIG. 15) may then switch the output level of its GPIO pin, and the MCU, upon detecting this switch, may initiate the reset operation for the USB host controller.

In an embodiment, the MCU, which controls the overall operation of the diagnosis and monitoring system, may detect the output level of the GPIO pin of the USB host controller (see FIG. 15). This ensures that tasks related to an optical link that has had its USB connection terminated or its power supply cut off are not performed. When the MCU detects a change in the USB host controller's GPIO pin output level, it may initiate a reset operation for the USB host controller, which in turn blocks the flow of data input and output related to the optical link that is now disconnected or has been powered down. As the data I/O flow from the USB host controller is blocked, the multiplexer (MUX) of the FPGA circuit (see FIG. 16) may implement Asynchronous Time Division Multiplexing (see FIG. 10B). This reassigns the time slot assigned to the now-idle data transmission channel to the data being input and output through the data transmission channels of the other connected optical links, preventing the MCU from performing tasks related to the disconnected or powered-off optical link. For example, in an embodiment, this reset operation on the USB host controller (see FIG. 15), which forms the USB communication channel for data I/O with the optical link, may fundamentally prevent data processing errors. By resetting the USB host controller, which directly transmits and receives I/O data to the optical link (the optical link's FPGA block, see FIG. 4, or an optical communication module containing the FPGA block, see FIGS. 4A and 4B), it may prevent erroneous data transmission and data processing within the data transmission channel formed in the diagnosis and monitoring system (see FIG. 14).

The communication module (see FIG. 14) may receive requests (control commands) that include Read, Write, Address, and Data from the administrator interface connected via an Ethernet communication network. It may also transmit diagnosis data to the administrator interface through the network. This diagnosis data includes at least one of the following: the connection status, the operational status, or the identification information of the a plurality of optical links that are USB-connected to the diagnosis and monitoring system. In an embodiment, the diagnosis and monitoring system may extract the access address of the administrator interface from the header of an IP packet containing a request (control command) received via a communication network. The system may then transmit the requested data (e.g., diagnosis data including at least one of the optical link's connection status, operational status, or identification information) by referencing the extracted access address. In various embodiments, the communication module may transmit various status information about a USB-connected optical link to the administrator interface via a communication network, in response to a request (control command). As described above, in addition to status information related to the optical link's connection (which may affect the video quality rendered on the display sink), the module may also acquire other status information from the relevant optical link (its FPGA block) and transmit it to the administrator interface. This includes identification information like the optical link's model name and serial number, and operational status such as its operating voltage and operating temperature.

For example, a manager or administrator interface (see FIG. 14), after checking the status of an optical link via a communication network, may transmit a request (control command) to the diagnosis and monitoring system to change the optical link's status. The system's communication module may receive these requests from the administrator interface, which may include commands to control the optical link's operation, such as powering a USB-connected optical link on or off. In an embodiment, an MCU that has received a power-off request (control command) for an optical link from the administrator interface may transmit a power-off control signal to the USB host controller connected to that link. The USB host controller may then cut off the power supply to the optical link, thus powering it off. Conversely, an MCU that has received a power-on request for an optical link from the administrator interface may transmit a power-on control signal to the USB host controller connected to that optical link. The USB host controller may then initiate the power supply to the optical link, powering it on. When the power supply is cut off or initiated, the USB host controller may either fail to detect the optical link's connection status or successfully detect it. Based on whether the optical link's connection status is detected, the host controller may then switch the output of its GPIO pin (see FIG. 15) to a high or low signal.

In an embodiment, the diagnosis and monitoring system (see FIG. 14) may perform diagnosis and monitoring on various status information of a plurality of optical links. This includes information on the connection status with the display source or display sink (which may affect the video quality rendered on the display sink), the optical link's operational status such as operating voltage and temperature, and the optical link's identification information. In this sense, the diagnosis data that may be monitored and managed through the diagnosis and monitoring system is comprehensive information about the optical link's various statuses. This includes the connection status (e.g., the presence of an output signal on the display source side and an input signal on the display sink side), the operational status (e.g., operating voltage or temperature), and the identification information of the optical link itself (e.g., model name or serial number). In various embodiments, the diagnosis and monitoring system may also provide diagnosis and monitoring and management for video auxiliary data, which includes at least one of the following: channel configuration data (related to the channel setup of the main channel for video data transmission) and rendering configuration data (related to the display sink's rendering performance). For example, the system may provide monitoring and management for video auxiliary data that includes channel configuration data such as DisplayPort Configuration Data (DPCD) and rendering configuration data like Extended Display Identification Data (EDID). More specifically, it may provide monitoring and management for video auxiliary data for each optical link (the optical link's FPGA block, see FIG. 14) by requesting and receiving video auxiliary data, and by modifying it. For example, a manager or administrator interface may optimize the system by requesting, receiving, and changing channel configuration data related to the main channel (or main lane). This allows them to check current settings, such as the emphasis level (pre-emphasis or de-emphasis) and the swing level (related to peak-to-peak voltage), and request a change to channel configuration data that is optimized for the optical link (e.g., requesting a change to optimized data when link training fails). Furthermore, by requesting, receiving, and changing rendering configuration data, a manager or administrator interface may verify the current rendering performance of the display sink (e.g., resolution and refresh rate) and request a change to rendering configuration data that is optimized for the display sink (e.g., to change the rendering performance to improve the display sink's video quality).

In an embodiment, the UART-parallel converter (see FIG. 14) may convert parallel communication data transmitted from the FPGA circuit into UART communication data and transmit it to the USB host controller. Conversely, it may convert UART communication data from the USB host controller into parallel communication data and transmit it to the FPGA circuit. At this time, the UART-parallel converter may check the output level of the USB host controller's GPIO pin (see FIG. 15) and may not perform the UART-parallel conversion for the data being input or output through the data transmission channel connected to that USB host controller. For example, when the output level of the USB host controller's GPIO pin switches to a low signal indicating the disconnection of a USB-connected optical link, the UART-parallel converter may not perform the UART-parallel conversion for data on the data transmission channel connected to the USB host controller whose output level has switched to a low signal. In an embodiment, the diagnosis and monitoring system (see FIG. 14) may include a plurality of UART-parallel converters, each of which may check the output level of the GPIO pin on the USB host controller connected to its data transmission channel. For example, each UART-parallel converter may check the output level of the USB host controller's GPIO pin (see FIG. 15) at preset periodic intervals. A UART-parallel converter whose connected USB host controller's GPIO pin is outputting a high signal may perform the UART-parallel conversion, while a converter whose connected USB host controller's GPIO pin is outputting a low signal may not perform the UART-parallel conversion. In various embodiments, the UART-parallel converter (see FIG. 14) connected to each data transmission channel may check the output level of the GPIO pin (see FIG. 15) of its connected USB host controller and may or may not perform the UART-parallel conversion based on the confirmed output level. Alternatively, under the control of an MCU that has checked the output level of the USB host controller's GPIO pin, the UART-parallel conversion may or may not be performed based on the GPIO pin's output level. In this case, the UART-parallel converter (see FIG. 14) and/or the MCU may check the output level of the USB host controller's GPIO pin (see FIG. 15) at a preset periodic interval. Based on this output level, the conversion operation of the UART-parallel converter may either be performed or not performed. In other words, the UART-parallel converter (see FIG. 14) connected to each data transmission channel may perform or not perform the UART-parallel conversion operation based on the output level of the USB host controller's GPIO pin connected to its own data transmission channel.

In an embodiment, the turn-on process of the diagnosis and monitoring system (see FIG. 14) may include an initialization process for each component connected to its data transmission channels. For example, the initialization of each UART-parallel converter may set up the UART communication channel, establishing parameters such as the baud rate, data bit, stop bit, and parity bit. In an embodiment, the UART communication channel may be set with a baud rate of 115200 bps, a data bit of 8 bits, a non-parity bit, and a one stop bit.

The communication module (see FIG. 14) may transmit diagnosis data received from each optical link to the administrator interface via a communication network. The communication module may also receive requests that include Read, Write, Address, and Data from the administrator interface via the network. For example, during the communication module's initialization, an Ethernet communication network may be set up by using User Datagram Protocol (UDP), and network information such as the IP address, Subnet Mask, Gateway, and MAC Address may be configured. The USB host controller may perform a hardware reset, and the controller's initialization following the reset operation may be carried out according to the design of its firmware.

An optical link that provides a diagnosis and monitoring function may be implemented by creating a data frame that transmits both video auxiliary data and diagnosis data together via a side channel by using Time Division Multiplexing (TDM). More specifically, this optical link may generate a data frame that includes both time-division multiplexed video auxiliary data and diagnosis data. The video auxiliary data, such as rendering configuration information for the video data rendered through the main channel and channel configuration information for the main channel, is transmitted over the side channel. Along with this, the optical link may also transmit diagnosis data, such as information about the connection status of the optical link (which forms the main and side channels for video data transmission), the operational status of the optical link, and the identification information of the optical link itself.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope of the disclosure as defined by the following claims.

What is claimed is:

1. An optical link for providing a diagnosis and monitoring function, forming a main channel through which video data is transmitted and a side channel through which video auxiliary data relating to a channel configuration of the main channel is transmitted, wherein a data frame is generated by time-division multiplexing to transmit, through the side channel, the video auxiliary data together with diagnosis data including status information of the optical link.

2. The optical link for providing a diagnosis and monitoring function, of claim 1, wherein
the data frame includes a special code area and a data area, which are assigned to time slots or sub-frames of a time-division multiplexed 8-unit.

3. The optical link for providing a diagnosis and monitoring function, of claim 2, wherein a special code assigned to the special code area includes control information for a time slot or sub-frame of a unit.

4. The optical link for providing a diagnosis and monitoring function, of claim 2, wherein, for the data frame, according to whether diagnosis data is present or not,
a data frame for a non-diagnosis instance, where no diagnosis data is present, includes a special code area and a data area that are alternately assigned to the time slots or sub-frames of the time-division multiplexed 8-unit, and
a data frame for a diagnosis instance, in which diagnosis data is present, includes, within the time slots or sub-frames of the time-division multiplexed 8-unit: a special code area assigned to a time slot or sub-frame of a unit corresponding to a beginning of the data frame; and a sequence of data areas assigned to time slots or sub-frames of other remaining units following the time slot or sub-frame of the unit to which the special code area is assigned, along a time axis.

5. The optical link for providing a diagnosis and monitoring function, of claim 4, wherein communication traffic related to the video auxiliary data, including a request for the video auxiliary data and a response to the request occurs more frequently than communication traffic related to diagnosis data, which includes a request for the diagnosis data and a response to the request.

6. The optical link for providing a diagnosis and monitoring function, of claim 4, wherein synchronous time-division multiplexing (STDM), in which, for the data frame of the non-diagnosis instance where the diagnosis data is not present, the time slot or sub-frame assigned to the diagnosis data is filled with stuffing symbols instead of video auxiliary data is implemented.

7. The optical link for providing a diagnosis and monitoring function, of claim 4, wherein the data frames of the non-diagnosis and diagnosis instances include a Video Interface Signal segment corresponding to the beginning of the data frame, and Side First, Side Second, and Side Third packet segments that follow the Video Interface Signal segment along the time axis,
the Video Interface Signal segment includes a special code area and a data area,
the special code area of the Video Interface Signal segment is assigned to a special code indicating the start of the data frame, and
the data area of the Video Interface Signal segment is assigned to video auxiliary data.

8. The optical link for providing a diagnosis and monitoring function, of claim 7, wherein each of the Side First, Side Second, and Side Third packet segments of the data frame of the non-diagnosis instance includes a special code area and a data area, and
the data areas of the Side First, Side Second, and Side Third packet segments are filled with stuffing symbols in place of diagnosis data that does not exist.

9. The optical link for providing a diagnosis and monitoring function, of claim 7, wherein each of the Side First, Side Second, and Side Third packet segments of the data frame of the diagnosis instance includes time slots or sub-frames of two-units that precede and follow along the time axis,
a preceding time slot of the Side First packet is filled with a diagnosis data start symbol, and a following time slot of the Side Third packet is filled with a diagnosis data end symbol, and
from a following time slot of the Side First packet to a preceding time slot of the Side Third packet, the time slots are filled with diagnosis data along the time axis.

10. The optical link for providing a diagnosis and monitoring function, of claim 10, wherein the preceding time slot or sub-frame of the Side First packet and the following time slot or sub-frame of the Side Third packet are filled with a diagnosis data start symbol and a diagnosis data end symbol, respectively, wherein the preceding time slot or sub-frame of the Side First packet and the following time slot or sub-frame of the Side Third packet are assigned as a modifiable data area between communication hosts.

11. The optical link for providing a diagnosis and monitoring function, of claim 2, wherein the time-division multiplexed time slots or sub-frames are assigned as 8 bits.

12. The optical link for providing a diagnosis and monitoring function, of claim 11, wherein the data frame is assigned as a total of 64 bits of eight units, with each unit being a time-division multiplexed time slot or sub-frame assigned as 8 bits.

13. The optical link for providing a diagnosis and monitoring function, of claim 1, wherein the optical link includes a Field-Programmable Gate Array (FPGA) block for generating the data frame, the FPGA block being connected to the side channel.

14. The optical link for providing a diagnosis and monitoring function, of claim 13, wherein the FPGA block includes a multiplexer for selecting and outputting an input channel assigned to a current time slot or sub-frame from among a plurality of input channels that are multiplexed through time-division multiplexed time slots or sub-frames.

15. The optical link for providing a diagnosis and monitoring function, of claim 14, wherein the data frame, according to whether diagnosis data is present or not,
during generation of a data frame for a non-diagnosis instance in which diagnosis data is not present, a special code, video auxiliary data, and stuffing symbols that replace diagnosis data are stored in a plurality of input channels of the multiplexer or a plurality of input registers connected to the plurality of input channels, and
during generation of a data frame for a diagnosis instance in which diagnosis data is present, a special code, video auxiliary data, and diagnosis data are stored in a plurality of input channels of the multiplexer or a plurality of input registers connected to the plurality of input channels.

16. The optical link for providing a diagnosis and monitoring function, of claim 14, wherein the FPGA block includes a Serializer+Deserializer (SerDes) for converting parallel data, output from an output channel of the multiplexer, into serial data, wherein the parallel data forms either a special code, video auxiliary data, and diagnosis data, or video auxiliary data and stuffing symbols.

17. The optical link for providing a diagnosis and monitoring function, of claim 16, wherein the SerDes outputs a sequence of serial data that forms a data frame in which video auxiliary data and diagnosis data or video auxiliary data and stuffing symbols are multiplexed, by taking as an input a sequence of parallel data that forms a data frame in which video auxiliary data and diagnosis data or video auxiliary data and stuffing symbols are multiplexed.

18. The optical link for providing a diagnosis and monitoring function, of claim 1, wherein the diagnosis data includes at least one of a connection status of the optical link, an operational status of the optical link, and identification information of the optical link itself.

19. The optical link for providing a diagnosis and monitoring function, of claim 1, wherein the video auxiliary data includes: channel configuration data related to channel configuration of a main channel for transmitting video data; and rendering configuration data related to rendering of a display sink where the video data is rendered.

20. An optical link for providing a diagnosis and monitoring function, the optical link including a main channel through which video data is transmitted and a side channel through which video auxiliary data is transmitted, wherein the video auxiliary data includes rendering configuration data of the video data transmitted via the main channel or channel configuration data of the main channel, and diagnosis data related to a status of the optical link is transmitted together with the video auxiliary data via the side channel.
